(19) United States
(12) Patent Application Publication
(10) Pub. No.: US 2026/0067025 A1
(43) Pub. Date: Mar. 5, 2026

(54) METHODS, ARCHITECTURES, APPARATUSES AND SYSTEMS FOR PACKET DATA CONVERGENCE PROTOCOL ROUTING ENHANCEMENTS FOR NETWORK CODING PROTOCOL DATA UNITS

(71) Applicant: InterDigital Patent Holdings, Inc., Wilmington, DE (US)

(72) Inventors: Ayesha Ijaz, Guildford (GB); Martino Freda, Laval (CA); Faris Alfarhan, Montreal (CA); Pascal Adjakple, Great Neck, NY (US); Benoit Pelletier, Roxboro (CA); Ghyslain Pelletier, Montreal (CA); Ahmed Almradi, Ipswich (GB); Salah Elhoushy, LaSalle (CA); Justin Cray, Philadelphia, PA (US)

(21) Appl. No.: 18/820,767

(22) Filed: Aug. 30, 2024

(51) Int. Cl. H04L 1/00; H04W 40/12

(52) U.S. Cl. CPC H04L 1/0009; H04L 1/0003; H04W 40/12

(57) ABSTRACT

Procedures, methods, architectures, apparatuses, systems, devices, and computer program products using wireless transmit/receive unit (WTRU) configured for receiving one or more service data units (SDUs); generating one or more protocol data units (PDUs) from network encoding of the one or more SDUs; selecting one or more transmission paths from a set of transmission paths based on one or more first parameters associated with the one or more PDUs and based on one or more second parameters associated with the one or more transmission paths; and transmitting the one or more PDUs via the one or more transmission paths.

### BACKGROUND

The present disclosure is generally directed to the fields of communications, software and encoding, including, for example, to methods, architectures, apparatuses, systems directed to mapping network coding (NC) protocol data units (PDUs) to different paths, resources in frequency domain, time domain, spatial domain, code domain etc. to improve radio resource efficiency and maximize benefits of network coding.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of a segmented-service data unit (SDU) based network coding;

FIG. 3 illustrates an example of a cross-SDU based network coding;

FIG. 4 illustrates an example of a cross-SDU based network coding;

FIG. 5 illustrates an example of NC as a protocol in PDCP;

FIG. 6 illustrates an example of a method of processing for routing NC PDU to radio link control (RLC) entities implemented by a WTRU;

FIG. 7 illustrates another example of a method of processing for routing NC PDU to RLC entities implemented by a WTRU; and

FIG. 8 illustrates an example of NC PDU routing activation/deactivation medium access control control element (MAC CE).

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

Provided below are acronyms/abbreviations for terms and phrases commonly used in this application:
ACK Acknowledgement
AM Acknowledged mode
BLER Block Error Rate
BS Base Station
CA Carrier Aggregation
CE Control Element
DC Dual Connectivity
IAB Integrated access and backhaul
LCH Logical Channel
MAC Medium Access Control
MCS Modulation and Coding Scheme
multi-TRPs Multiple transmission and reception points
NACK Negative-Acknowledgement
NAS Non-Access Stratum
NC Network Coding
NR New Radio
PDCP Packet Data Convergence Protocol
PDU Protocol Data Unit
QFI QoS Flow Identifier
QoS Quality of Service
RB Radio Bearer
RLC Radio Link Control
RLF Radio Link Failure
RRC Radio Resource Control
RSRP Reference Signal Received Power
RSRQ Reference Signal Received Quality
RSSI Received Signal Strength Indicator
SDU Service Data Unit
SINR Signal-to-interference and noise ratio
TB Transport Block
UE User Equipment
URLLC Ultra-Reliable and Low Latency Communications
V2X Vehicle to everything
WLAN Wireless Local Area Networks and related technologies (IEEE 802.xx domain)

Hereinafter, “a” and “an” and similar phrases are to be interpreted as “one or more” and “at least one”. Similarly, any term which ends with the suffix “(s)” is to be interpreted as “one or more” and “at least one”. The term “may”is to be interpreted as “may, for example”.

A symbol “/” (e.g., forward slash) may be used herein to represent “and/or”, where for example, “A/B”may imply “A and/or B”.

### Example Communications System

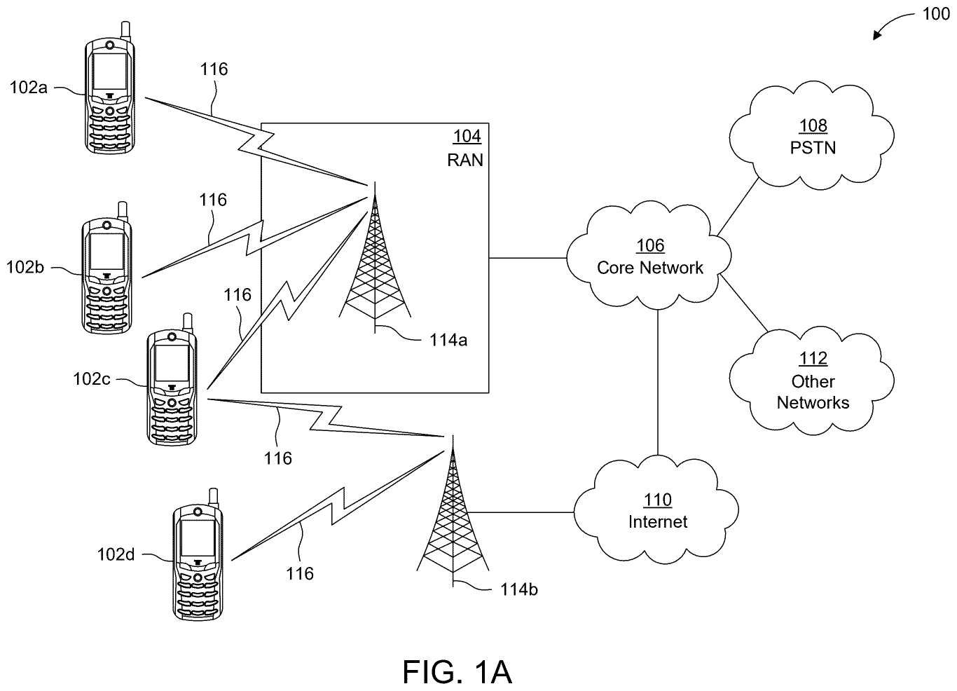

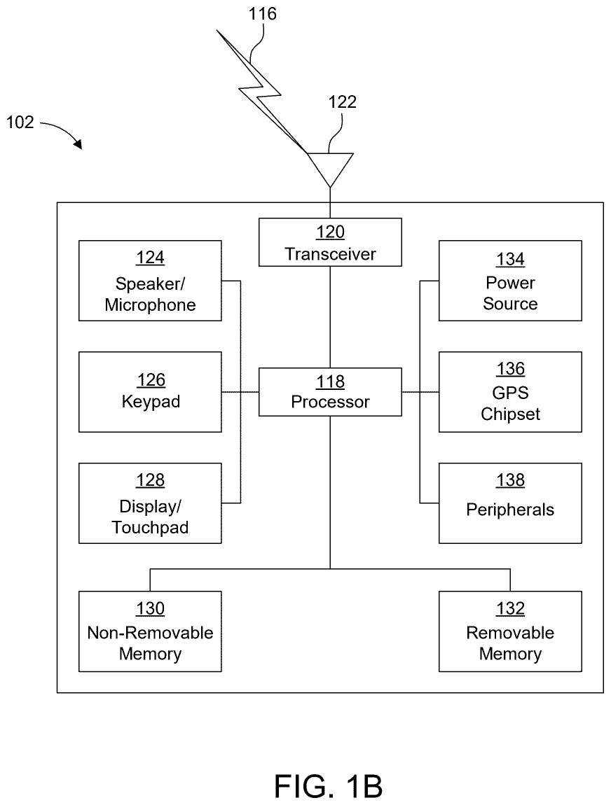

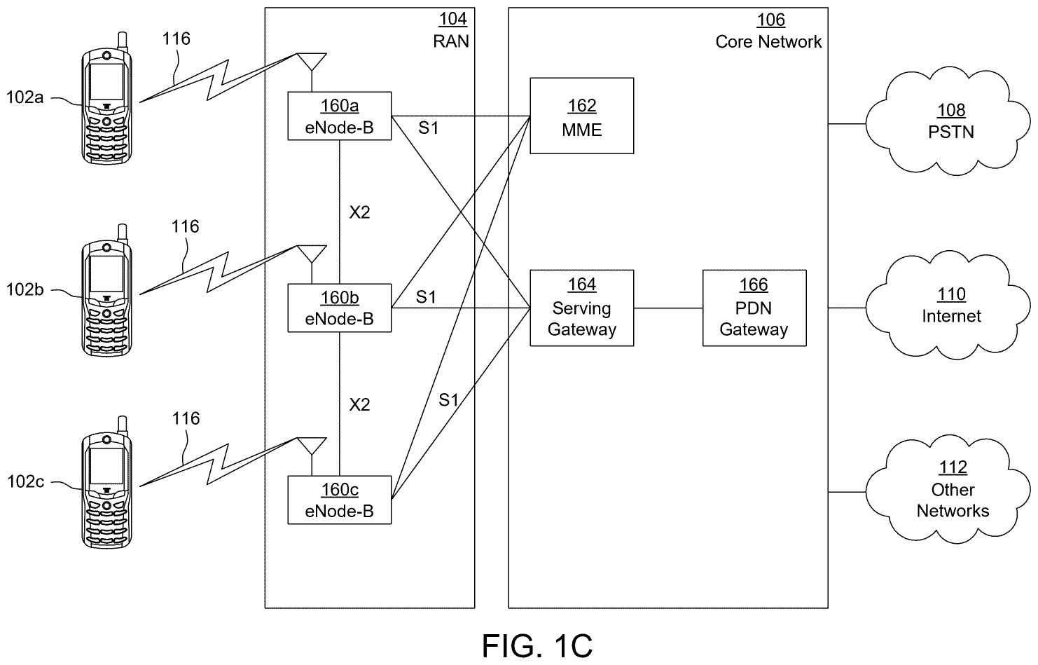

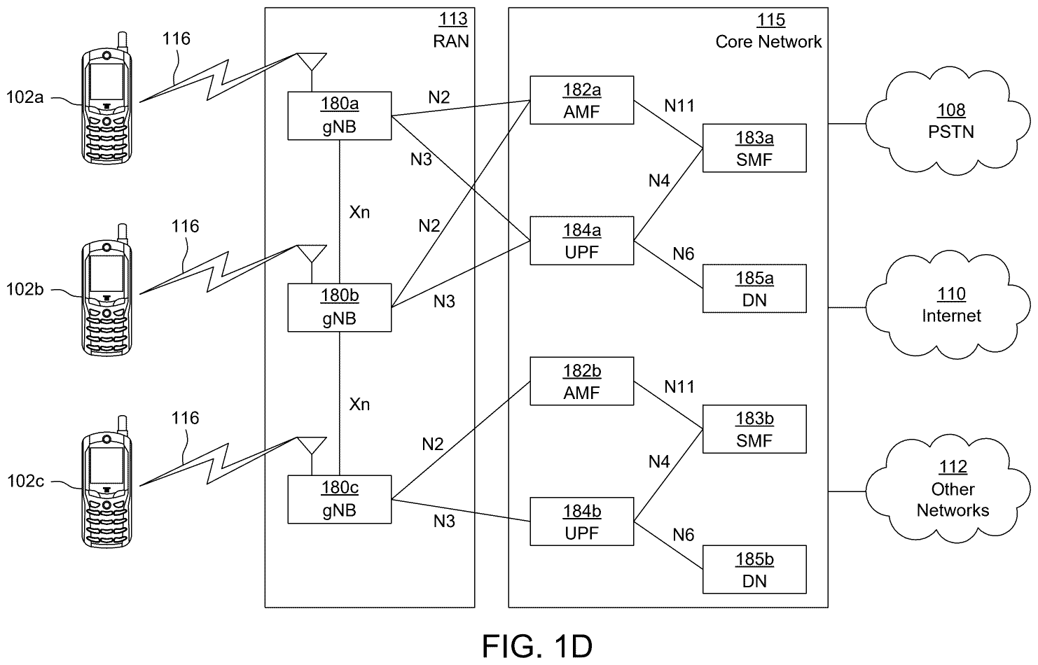

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xₙ interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The 5G NR design supports PDCP duplications and transmission of transport blocks (TBs) over multiple transmission and reception points (multi-TRPs) in support of ultra-reliable and low latency communication services. Considering increasing requirements in terms of various key performance metrics such as spectral efficiency, latency, reliability, data rate and the need for a concurrent support of these requirements, the use of redundancy via duplication as a solution is not efficient and not scalable.

Network coding can provide flexible redundancy coding rate for different reliability requirements and flexible split of transmission of coded packets over different transmission paths (e.g., frequency diversity, spatial diversity, code diversity) or over different time instances (for time domain diversity). Network coding may be applied with or without PDCP duplication; use of network coding may alleviate a scheduler from having to select conservative MCS transmission parameters and/or improve the allocation of other transmission resources to improve overall system performance. In reference to the existing 5G system, network coding can be used to improve efficiency for the support of multicast broadcast services, sidelink services (e.g., V2X services), enhanced mobile broadband services with the added benefits of better link efficiency, reduced latency, improved reliability, and reduced buffering requirements. Examples of deployment scenarios include CA (Carrier Aggregation), DC (Dual Connectivity), IAB (Integrated access and backhaul), sidelink including sidelink relay.

Herein, network coding is a packet processing function that transforms X input packet(s) (also called as source packets) into Y output packet(s), which is denoted as coded packet(s) hereinafter. In general X is greater or equal to 2 and Y is greater or equal to X, with the case X equal to 1 and Y equal to 1 being a special case. The X input packets being coded together form a network coding generation (denoted hereinafter a NC generation or simply a generation). A generation will have a generation identifier such as a sequence number that is used to associate packets to the generation the packets are generated from. An input packet may be an NC SDU or a segment of an NC SDU. An output packet is denoted as a NC PDU. Network coding is therefore a packet processing function that transforms X NC SDU(s) or NC SDU-segments into Y NC PDUs, wherein each NC PDU is a different linearly independent combination of the NC SDUs or NC SDU-segments that form the NC generation being encoded into NC PDUs. In other words, a first NC PDU generated using the NC generation is obtained based on a first linear combination of the set of NC SDUs or NC SDU-segments using a first set of coding coefficients, and a second PDU generated using the NC generation is obtained based on a second linear combination of the set of NC SDUs or NC SDU-segments using a second set of coding coefficients different from the first set of coding coefficients. The first NC PDU (i.e., the first linear combination of the set of NC SDUs) and the second NC PDU (i.e., the second linear combination of the set of NC SDUs) are linearly independent. The NC PDUs associated with the same generation (i.e., generated using the same generation) may be of same or different characteristics, and therefore associated with same or different importance/priority levels. Such characteristics may be systematic packets, coded packets, less-innovative coded packets, more-innovative coded packets, size of a NC SDU or SDU-segment of the generation for example in number of bits or octets, size of the NC PDU for example in number of bits or octets, size of a coding coefficient for example in number of bits or octets etc. Furthermore, there may be dependencies between NC PDUs of the same generation in the sense that: a) the receiver needs to correctly receive i.e. successfully decode X linearly-independent NC PDUs or more to recover the X NC SDUs; b) how many more NC PDUs or specific NC PDUs are used (e.g., needed) by the receiver to recover the X NC SDUs depends on the NC PDUs already successfully decoded by the receiver; c) the scheduling of the NC PDUs generated using the same generation is constrained by the same overall delay budget From the receiver perspective, when it receives at least X out of Y transmitted NC PDUs, it can recover the transmitted information i.e., the X NC SDUs or X NC SDU-segments. As a result, even if the receiver fails to successfully decode all received NC PDUs, it can still recover the NC SDUs or SDU-segments.

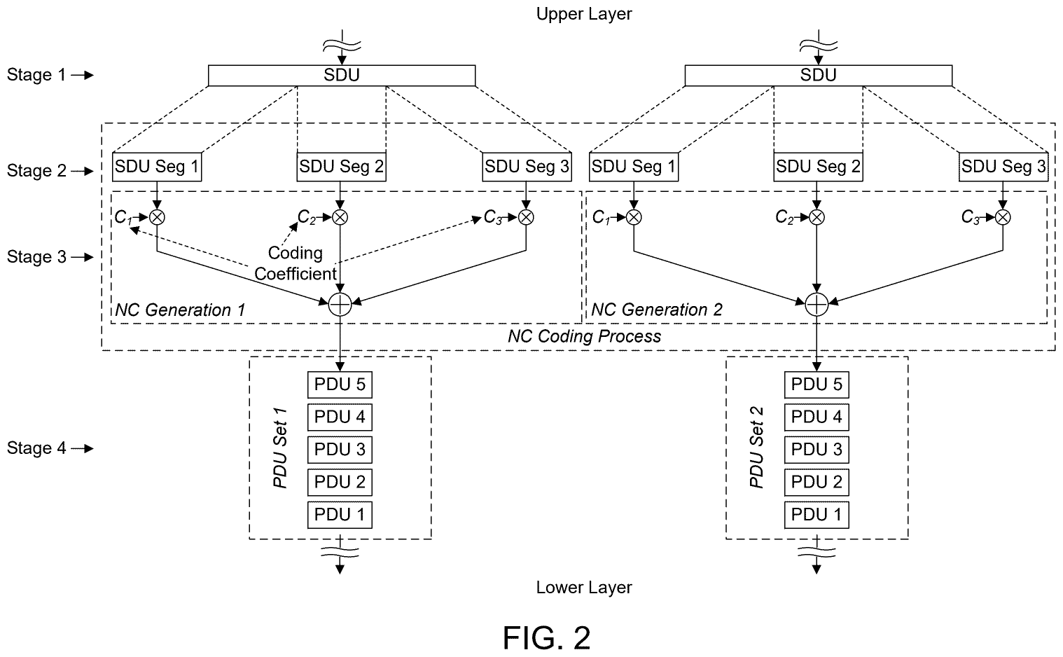

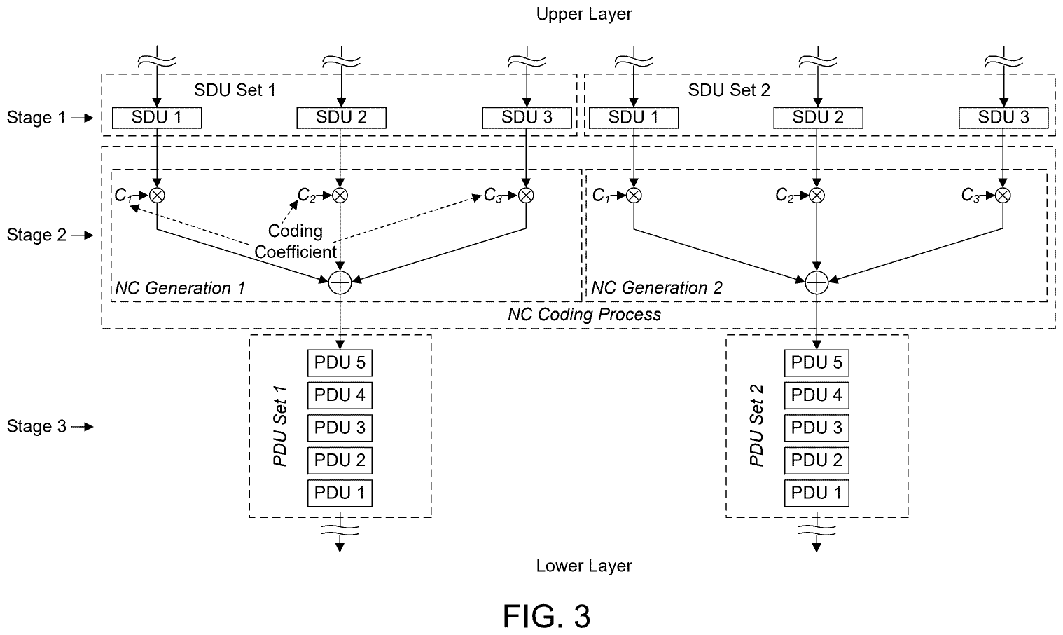

FIG. 2 shows segmented-SDU based NC in which one NC SDU is segmented and NC is performed on the segments (i.e., one-to-many mapping). FIG. 3 shows cross-SDU based NC in which NC is performed using multiple SDUs per NC generation (i.e., many-to-many mapping). Given that NC PDUs from the same generation (or different generations) may have different characteristics, enhancements to the existing PDU routing mechanisms to account for the dependencies between NC PDUs, need to be investigated.

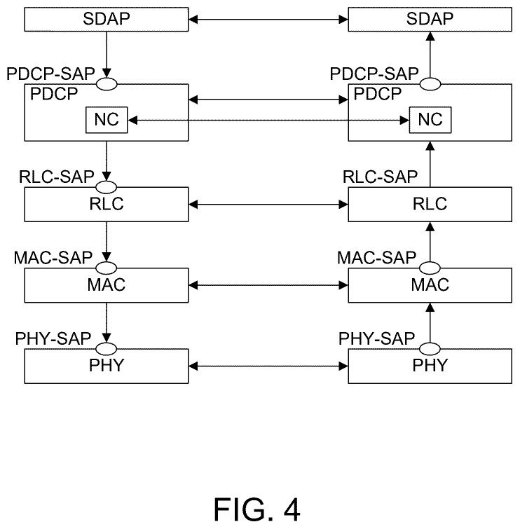

While this description assumes by way of example, NC as protocol in PDCP (FIG. 4), it should be noted that one or more embodiments described herein apply to any packet processing method (e.g., any maximum-distance separable codes such as RaptorQ code, Reed-Solomon code, etc.) that takes X SDUs and produces Y PDUs, wherein each PDU is a different linearly independent combination of the X SDUs, and at least X PDUs are used (e.g., needed) for the successful recovery of the X SDUs. It is assumed that the input to the coding protocol/function is perfectly reliable, i.e., at the receiver, the received PDU would have successfully passed CRC check before being processed by the coding protocol/function located in a protocol that is post-CRC-check processing (e.g., above HARQ, including the application layer). Furthermore, it is assumed network coding as defined herein may be applied to packets that have been already processed through network coding i.e., NC SDUs may be network coded packets e.g., for scenarios with recoding where network coding is applied at more than one node located in the processing path of a packet.

The concept of PDU and PDU set was introduced in 3GPP R18, however, the difference here is that the NC PDUs are PDUs generated by the protocol layer that implements NC e.g., as shown in FIG. 3, and not PDUs of application layer.

Herein, the term NC PDU header of an NC PDU will be used in reference to a header information specific to the NC protocol that generates the NC PDU, or a header information of any other protocol that either implements NC or is part of the upper layer protocols or lower layer protocols relative to the protocol that implements NC.

Methods and apparatus are provided for allowing a WTRU (e.g., UE) to route one or more NC PDUs to one or more paths as a function of one or more of NC PDU characteristics and characteristics of the paths.

Methods and apparatus are provided for allowing a WTRU (e.g., UE) to determine importance of NC PDU based on one or more of remaining delay budget, level of innovativeness and number of NC PDUs required to recover NC SDUs associated with the NC generation used to generate the NC PDU.

Methods and apparatus are provided for allowing a WTRU (e.g., UE) to determine one or more suitable paths for transmission of NC PDUs based on one or more of link quality on a path, NC PDU characteristics, QoS requirements of NC PDUs, and PDCP lower layers configuration etc.

Methods and apparatus are provided for enhancements to PDCP routing for NC PDUs when NC is performed as an extension to or replacement of PDCP duplication.

In legacy systems, when packet PDCP duplication is activated for a radio bearer, whether it is CA duplication or DC duplication, all PDCP Data PDUs are submitted to both the primary and secondary (RLC) paths activated for PDCP duplication. In PDCP duplication, which can be considered as a special case of network coding, there is no routing decision. In split bearer case, routing to secondary path may be performed based on volume threshold. However, this rationale may not be adequate in the case of network coding since all NC PDUs generated using one or more NC generations may not be created equally and, therefore, they can be treated differently for mapping to different paths, e.g., RLC entities, for transmission on different radio resources in frequency domain, time domain, spatial domain, code domain etc. to improve radio resource efficiency and maximize benefits of network coding. Hence, it needs to be addressed how to account for dependencies between NC PDUs generated using the same NC generation and treat different NC PDUs differently when routing NC PDUs to different paths in a way that is resource efficient, reduces transmission delay and maximizes performance benefits of network coding.

NC may not be supported in NR. Methods and apparatus are provided to map NC PDUs with different characteristics to different transmission paths (e.g., RLC entities, radio resources (e.g., time/frequency/spatial/code domain) etc.) whilst accounting for dependencies between NC PDUs generated using the same NC generation.

One or more examples described herein may be used separately or in combination for the WTRU to route one or more NC PDUs to one or more paths as a function of one or more of NC PDU characteristics (e.g., type, innovativeness, importance etc.) and characteristics of the paths e.g., allowed PDU characteristics, link quality, RLC entity and corresponding lower layer configuration (such as mode of data transfer, MCS, carrier type, cell group, radio resources e.g., frequency/time/spatial/code domain resources etc.).

A WTRU (e.g., UE) may be configured with: a set of RLC entities with one or more path characteristics e.g., allowed NC PDU characteristics, MCS values, grant type, carrier type, cell group type, mode of data transfer etc.

According to some embodiments, the WTRU (e.g., UE) may be configured with: conditions for routing NC PDUs to paths (e.g., RLC entities) as a function of one or more of NC PDU characteristics (e.g., type, innovativeness, importance etc.), remaining delay budget, NC configuration and path characteristics (e.g., link quality, RLC entity and corresponding lower layer configuration e.g., mode of data transfer, LCH mapping restrictions, modulation and coding scheme (MCS), radio resources e.g., frequency/time/spatial/code domain resources such as timeslots, cell group, component carriers, bandwidth parts, beams etc.).

The WTRU (e.g., UE) may receive data in its buffer and applies NC to NC SDUs, generating NC PDUs.

The WTRU (e.g., UE) may determine importance of NC PDU as function of one or more of its remaining delay budget, level of innovativeness, number of NC PDUs required (denoted herein as X_{req}) at the receiver to recover the NC SDUs associated with the NC generation used to generate the NC PDUs. E.g., an NC PDU is of higher importance if remaining delay budget is below a threshold and, the NC PDU is determined to be an NC PDU that counts towards the number of NC PDUs required at the receiver to recover the NC SDUs of the NC generation used to generate the NC PDUs, otherwise the NC PDU is of lower importance.

The WTRU (e.g., UE) may map NC PDUs to one or more suitable paths e.g., RLC entities, based on pre-configured conditions (e.g., see above)). E.g., if NC code rate of the NC generation used to generate NC PDUs is below a threshold, the WTRU (e.g., UE) maps NC PDUs to a first set of paths (e.g., RLC entities). Otherwise, if code rate of NC generation used to generate NC PDUs is above the threshold, the WTRU (e.g., UE) maps NC PDUs to a second set of paths (e.g., RLC entities) wherein the second set of paths may be configured with configurations (e.g., RLC entity or lower layers configuration) which may provide higher transmission reliability (e.g., lower error rate) than the configuration configured for the first set of paths. E.g., if importance of NC PDU is above a threshold, the WTRU (e.g., UE) transmits NC PDU via more than one paths (e.g., RLC entities). Otherwise, the WTRU (e.g., UE) transmits NC PDUs (with importance lower than the threshold) via single path (e.g., RLC entity).

According to some embodiments, the WTRU (e.g., UE) may map NC PDUs with importance higher than a threshold to a first set of one or more paths (e.g., RLC entities) associated with a first set of configuration (e.g., RLC entity or lower layers configuration) whereas WTRU (e.g., UE) maps NC PDUs with importance lower than the threshold to a second set of one or more paths associated with a second set of configuration, wherein the first set of configuration provides higher transmission reliability than the second set of configuration e.g., via higher number of configured grant repetitions, a first set of (e.g., lower order) MCS values etc.

According to some embodiments, if remaining delay budget of NC PDUs generated using an NC generation is below a configured threshold, the WTRU (e.g., UE) may transmit NC PDUs generated using the NC generation via more than one set of paths (e.g., RLC entities) to support recovery of NC SDUs associated with the NC generation within a certain delay bound. Otherwise, the WTRU (e.g., UE) may transmit NC PDUs generated using the NC generation via one set of paths (e.g., RLC entities) wherein a set of paths (e.g., RLC entities) may comprise of single or multiple paths (e.g., RLC entities).

According to some embodiments, if NC PDU is of first type (e.g., systematic NC PDU), the WTRU (e.g., UE) may transmit NC PDU via a first set of one or more paths with better link quality (e.g., based on radio measurement) than a second set of paths. Otherwise, the WTRU (e.g., UE) may transmit NC PDU of second type (e.g., non-systematic NC PDU) via second set of paths.

Adaptive mapping of NC PDUs to paths configured for data transfer with higher reliability, as a function of radio conditions and characteristics of NC PDUs may increase probability of successful data transmission within a certain delay bound and reduces waste of system resources, and/or may allow to adapt amount of overall redundancy without changing NC configuration. This in turn reduces control overhead which may incur e.g., for signaling change in NC configuration.

The embodiments in this description may be mainly focused on enhancements for PDCP routing wherein a transmit PDCP entity routes NC PDUs to one or more RLC entities. However, the embodiments are applicable to any entity (e.g., in application layer, non-access stratum layer or access stratum layer, network function or node, device function or node, etc.) which may forward NC PDUs for transmission over different paths (e.g., flows, entities, resources) such as QoS flows (e.g., QFIs), radio bearers (RBs), logical channels (LCHs), time domain resources, frequency domain resources, spatial domain resources, code domain resources, transmission or processing resources, etc.

In this description, the term “NC PDU”and “packet”may be used interchangeably.

In this description, the WTRU (e.g., UE) is “configured with” or “(pre)-configured with” may refer to the scenario that the WTRU (e.g., UE) receives a configuration from the base station or another node. For the case that the WTRU (e.g., UE) receives configuration from the base station, the WTRU (e.g., UE) may receive a dedicated RRC configuration or SIB or L1/L2 signaling from the base station. For the case that the WTRU (e.g., UE) receives configuration from another node, the WTRU (e.g., UE) may receive configuration e.g., via sidelink communication (e.g., PC5 RRC, PC5 NAS signaling), via Uu reference point NAS signaling for example in the case another node is located in the core network, via application layer signaling for example in the case another node is located in the service network, etc.

The WTRU (e.g., UE) is “configured” or “(pre)-configured” to perform an action may also refer to the scenario that the WTRU (e.g., UE) is hard coded to perform the action e.g., via standard specifications.

An innovative packet or innovative NC PDU is a coded packet that when received is useful for decoding the generation i.e., increases the rank of the generator matrix used to generate the NC PDUs. This implies that an innovative NC PDU is formed with coefficients that are linearly independent from coefficients used to generate other NC PDUs generated using the same generation of NC SDUs already received. In this description, the term innovative PDU in the context of a transmitter may refer to an NC PDU that is linearly independent from NC PDUs which were previously transmitted/selected for transmission, or in the context of a receiver may refer to an NC PDU that is linearly independent from NC PDUs which were previously received.

In this description, the term “level of innovativeness” may refer to a usefulness of the packet when decoding a generation of packets. Some packets will only enable the decoding of a small amount of source packets while others will enable the decoding of a large amount of source packets. In this description, the term more-innovative refers to an NC PDU that includes information about a larger number of source packets i.e., NC SDUs when compared to a less-innovative NC PDU. In other words, an NC PDU PDU1 is more innovative than an NC PDU PDU2, if PDU1 is coded as a linearly independent combination of K1 NC SDUs, PDU2 is coded as a linearly independent combination of K2 NC SDUs, and K1 is greater than K2. According to certain embodiments, a threshold denoted herein Kᵢₙₙₒᵥₐₜᵢᵥₑ may be defined. An NC PDU PDU1 is more innovative if the NC PDU PDU1 is coded as a linearly independent combination of at least Kᵢₙₙₒᵥₐₜᵢᵥₑ NC SDUs. The term less-innovative NC PDU may refer to an NC PDU that will enable decoding of a smaller amount of NC SDUs when compared to a more-innovative NC PDU. In other words, an NC PDU PDU1 is less innovative than an NC PDU PDU2, if PDU1 is coded as a linearly independent combination of K1 NC SDUs, PDU2 is coded as a linearly independent combination of K2 NC SDUs, and K1 is smaller than K2. According to certain embodiments, an NC PDU PDU1 is less innovative if PDU1 is coded as a linearly independent combination of less than Kᵢₙₙₒᵥₐₜᵢᵥₑ NC SDUs.

In this description, the term “on-the-fly decoding” may refer to some innovative NC PDUs enabling the recovery of at least one but not all NC SDUs that form a generation. In this case, the receiver may (optionally) attempt to immediately recover some of the NC SDUs even though more NC PDUs will be used (e.g., needed) to recover all the NC SDUs that form the generation. While multiple rounds of decoding require additional computation for the receiver, immediate recovery of some NC SDUs may reduce the delay in the reception of these packets.

Latency requirement or a delay budget of an NC PDU associated with an NC generation can be defined as the delay budget of the one or more NC SDUs that form the NC generation. Similarly, a delay budget of an NC generation can be defined as the delay budget of the one or more NC SDUs that form the NC generation.

According to certain embodiments, in the case of segmented-SDU based NC, the delay budget of an NC PDU is the delay budget of the SDU segmented to form the NC generation, while in the case of cross-SDU NC, the delay budget of an NC PDU associated with an NC generation may be the delay budget of an SDU with the minimum delay budget among the delay budgets of the SDUs that form the NC generation. Herein, the delay budget of an NC generation is the delay budget of the one or more NC SDUs that form the NC generation. In the case of segmented SDU based NC, the delay budget of an NC generation is the delay budget of the SDU segmented to form the NC generation, while in the case of cross-SDU NC, the delay budget of an NC generation may be the delay budget of an SDU with the minimum delay budget among the delay budgets of the SDUs that form the NC generation. A delay budget of an NC generation or an NC PDU may be initialized with an initial delay budget value. Such value may be a configured value for an NC generation, or may be derived from the delay budget values configured for the one or more of the SDUs that form the NC generation. At any given point in time, a remaining delay budget is the delay budget that remains, taking into account the elapsed time since the delay budget is initialized. A delay budget of an NC generation and associated PDUs may be initialized for example at the creation of the generation, or at the reception of the corresponding SDU(s) from upper layer, etc.

In this description, the terms “latency requirement”, and “remaining delay budget” of NC PDU(s) may be used interchangeably.

In this description, the link quality of a path between a transmitter node (e.g., UE) and receiver node (e.g., gNB) may refer to one or any combination of the following: (1) RLF status between transmitter and receiver; (2) synchronization status between transmitter and receiver; (3) beam management status; (4) layer 1 or layer 3 measurements of transmission(s) on a path between two nodes; (5) distance between two nodes; (6) expected latency of a data unit traveling the path; or (7) difference between the expected latency of the path and the remaining delay budget of the data unit for which a routing decision is being made.

In the case of RLF status between transmitter and receiver, for example, the link quality of path between transmitter and receiver may refer to whether radio link failure (RLF) is detected/declared by the evaluating node (e.g., UE) on the path.

In the case of synchronization status between transmitter and receiver, for example, the link quality of path between transmitter and receiver may refer to whether the WTRU (e.g., UE) is synchronized with the gNB.

In the case of beam management status, for example, the link quality of a path between two nodes may refer to whether beam failure is detected/declared by the evaluating node (e.g., evaluating WTRU (e.g., UE)) on the path.

Layer 1 or Layer 3 measurements of transmission(s) on a path between two nodes, may include but are not limited to RSRP, RSRQ, SINR, RSSI, Pathloss, BLER, etc. According to certain embodiments, the L1 or L3 measurement may be performed at the evaluating node (e.g., evaluating WTRU (e.g., UE)) for the path. According to certain embodiments, the L1 or L3 measurement for a path may be performed at the peer node (e.g., gNB) and sent to the evaluating node (e.g., evaluating WTRU (e.g., UE)). For example, the link quality of a path between two nodes may refer to the L3 RSRP of transmission from the peer node on the path.

In the case of distance between two nodes, for example, the link quality of a path between two nodes may refer to the distance (e.g., number of hops) between the two nodes on the path. For example, the WTRU (e.g., UE) may determine the link quality between two nodes as good if the distance between two nodes is smaller than a configured threshold. Otherwise, the WTRU (e.g., UE) may determine the link quality between two nodes as not good.

In the case of expected latency of a data unit traveling the path, for example, the lower the latency, the better the link quality.

Difference between the expected latency of the path and the remaining delay budget of the data unit for which a routing decision is being made.

The WTRU (e.g., UE) may determine an importance of NC PDU generated using an NC generation based on one or more of remaining delay budget, level of innovativeness and number of NC PDUs required to recover NC SDUs associated with the NC generation used to generate the NC PDU]

According to certain embodiments, a WTRU (e.g., UE) may be configured to determine importance of an NC PDU, e.g., to determine how to map an NC PDU to one or more paths (e.g., RLC entities), as a function of one or more of the remaining delay budget of NC PDU, level of innovativeness, type of NC PDU, importance of NC SDU(s) associated with the NC generation used to generate the NC PDU and number of NC PDUs required to recover NC SDUs forming the NC generation used to generate the NC PDU. According to certain embodiments, the WTRU (e.g., UE) may determine importance of an NC PDU based on any of the following: (1) remaining delay budget of NC PDU; (2) innovativeness of NC PDU; (3) type of NC PDU; (4) based on the NC PDU enabling the recovery of NC SDU(s) using on-the-fly-decoding; (5) importance of NC SDU(s); (6) importance of NC generation; or (7) number of NC PDUs required to recover NC SDUs associated with the NC generation used to generate the NC PDU (denoted herein as X_{req}).

In the case that the WTRU (e.g., UE) determines importance of an NC PDU based on remaining delay budget of NC PDU, for example, the WTRU (e.g., UE) may determine that an NC PDU1 is of higher importance than an NC PDU2 if the remaining delay budget of the NC PDU1 is below a (pre)-configured first threshold and remaining delay budget of the NC PDU2 is above the first threshold.

In the case that the WTRU (e.g., UE) determines importance of an NC PDU based on innovativeness of NC PDU, for example, the WTRU (e.g., UE) may determine that an NC PDU generated using an NC generation is of high importance if the WTRU (e.g., UE) determines that it is an innovative NC PDU i.e. linearly independent from one or more NC PDUs, generated using the same NC generation, which the WTRU (e.g., UE) may have already transmitted (e.g., transmitted in a transport block, or determined by the WTRU (e.g., UE) as successfully received at the receiver based on positive acknowledgement received by the WTRU (e.g., UE) from the receiver), or submitted to lower layers buffers, or selected for submission to lower layers. Otherwise, the WTRU (e.g., UE) may determine that the NC PDU is of low importance.

In the case that the WTRU (e.g., UE) determines importance of an NC PDU based on a type of NC PDU, for example, the WTRU (e.g., UE) may determine that an NC PDU is of high importance if it is a systematic NC PDU. Otherwise, the WTRU (e.g., UE) may determine that the NC PDU is of low importance if the NC PDU is non-systematic NC PDU.

In the case that the WTRU (e.g., UE) determines importance of an NC PDU based on the NC PDU enabling the recovery of NC SDU(s) using on-the-fly-decoding, for example, the WTRU (e.g., UE) may determine that a NC PDU is of high importance if the receiver is performing on-the-fly decoding and upon reception of the NC PDU the receiver can use on-the-fly decoding to recover one or more NC SDUs. Otherwise, the WTRU (e.g., UE) may determine that the NC PDU is of low importance.

In the case that the WTRU (e.g., UE) determines importance of an NC PDU based on the NC PDU enabling the recovery of NC SDU(s) using on-the-fly-decoding, for example, the WTRU (e.g., UE) may determine that a NC PDU that enables the recovery of more NC SDUs via on-the-fly decoding than another NC PDU is of higher importance.

In the case that the WTRU (e.g., UE) determines importance of an NC PDU based on the importance of NC SDU(s), for example, the WTRU (e.g., UE) may determine that an NC PDU is of high importance if the importance of one or more of NC SDUs associated with the NC generation used to generate the NC PDU is high. Otherwise, the WTRU (e.g., UE) may determine that the NC PDU is of low importance.

In the case that the WTRU (e.g., UE) determines importance of an NC PDU based on the importance of NC SDU(s), for example, the WTRU (e.g., UE) may determine that an NC PDU is of high importance if the importance of one or more (e.g., configured number) of NC SDUs associated with the NC generation used to generate the NC PDU is higher than a threshold level. Otherwise, if the number of SDUs with importance higher than the threshold level is below the configured number, the WTRU (e.g., UE) may determine that the NC PDU is of low importance.

In the case that the WTRU (e.g., UE) determines importance of an NC PDU based on the importance of NC SDU(s), for example, if NC PDU is generated using different segments of single NC SDU, the WTRU (e.g., UE) may determine that importance of NC PDU is equal to the importance of the NC SDU.

In the case that the WTRU (e.g., UE) determines importance of an NC PDU based on the importance of NC SDU(s), for example, the WTRU (e.g., UE) may determine that importance of NC PDU is average/mean of importance of NC SDUs used to generate the NC PDU.

In the case that the WTRU (e.g., UE) determines importance of an NC PDU based on the importance of NC SDU(s), for example, the WTRU (e.g., UE) may determine that importance of NC PDU is equal to the importance of NC SDU with the highest or lowest importance among the NC SDUs used to generate the NC PDU.

In the case that the WTRU (e.g., UE) determines importance of an NC PDU based on the importance of NC SDU(s), for example, the WTRU (e.g., UE) may determine that a NC PDU that enables the recovery of more NC SDUs via on-the-fly decoding has an importance that is the average/mean of the SDUs that may be recovered via on-the-fly decoding.

In the case that the WTRU (e.g., UE) determines importance of an NC PDU based on the importance of NC generation, for example, the NC PDUs generated using an NC generation may have importance level equivalent to the importance level of the NC generation.

In the case that the WTRU (e.g., UE) determines importance of an NC PDU based on X_{req}, for example, the WTRU (e.g., UE) may determine that an NC PDU is of high importance if X_{req} NC PDUs generated from the NC generation are not already transmitted, or not yet selected for submission to lower layers, wherein the WTRU (e.g., UE) may determine X_{req} autonomously or based on feedback from the network.

In one example, the WTRU (e.g., UE) may determine number of NC PDUs required to recover NC SDUs associated with an NC generation based on e.g., radio conditions, NC configuration etc. as the absolute number of NC PDUs required to recover NC SDUs associated with the NC generation used to generate the NC PDUs.

For example, the WTRU (e.g., UE) may determine X_{req} is equal to X linearly independent NC PDUs i.e. WTRU (e.g., UE) determines X_{req} as the minimum number of linearly independent NC PDUs required to recover NC SDUs associated with the NC generation used to generate the NC PDUs.
For example, the WTRU (e.g., UE) may determine X_{req} as function of link quality, NC generation size and NC code rate. Specifically, if link quality is above a first threshold, the WTRU (e.g., UE) may determine X_{req} is equal to X linearly independent NC PDUs. If link quality is equal or below a second threshold that may belong to a set of thresholds with Nₜₕᵣ levels/values which are below a first threshold, the WTRU (e.g., UE) may determine that X_{req} is equal to X +X_{add,n} linearly independent NC PDUs generated using the NC generation. Wherein, n=0, 1, . . . Nₜₕᵣ−1 and X_{add,n} denotes minimum number of additional linearly independent NC PDUs required to recover NC SDUs associated with the NC generation used to generate the NC PDUs if link quality is below the n-th threshold level.
For example, the WTRU (e.g., UE) may determine X_{req} is equal to Y i.e. total number of NC PDUs generated using an NC generation.

In another example, the WTRU (e.g., UE) may determine number of NC PDUs required to recover NC SDUs associated with the NC generation based on one or more of feedback information received from the receiver, number of NC PDUs already transmitted, and number of NC PDUs submitted to lower layers. According to certain embodiments, the WTRU (e.g., UE) may receive an L2 or L1 level feedback explicitly indicating number of additional NC PDUs required for decoding the NC SDUs associated with the NC generation. According to certain embodiments, the WTRU (e.g., UE) may determine number of additional NC PDUs required for decoding the NC SDUs associated with the NC generation based on L2 or L1 level feedback indicating e.g., the number of NC PDUs successfully received at the receiver wherein NC PDUs are generated using the NC generation, success ratio of reception of NC PDUs generated using the NC generation, acknowledgement/Negative-Acknowledgement (ACK/NACK) feedback for the NC PDUs transmitted by the WTRU (e.g., UE), etc.

For example, if the UE determines (e.g., based on feedback received from the network or receiver) that the receiver (e.g., gNB) has received minimum of X_{rec} NC PDUs generated using an NC generation and the WTRU (e.g., UE) determines that it has already submitted X_{¿} NC PDUs to lower layers, the WTRU (e.g., UE) may determine number of NC PDUs required to recover NC SDUs associated with the NC generation as X_{req}=X−X_{rec}−X_{¿} wherein X is the size of NC generation used to generate NC PDUs.

For example, if the WTRU (e.g., UE) determines (e.g., based on feedback received from the network or receiver) that the receiver (e.g., gNB) requires X_{req,rec} NC PDUs to recover NC SDUs associated with an NC generation used to generate the NC PDUs and the WTRU (e.g., UE) determines that it has already submitted X_{¿} NC PDUs to lower layers, the WTRU (e.g., UE) may determine number of NC PDUs required to recover NC SDUs associated with the NC generation as X_{req}=X_{req,rec}−X_{¿}.

For example, if the WTRU (e.g., UE) determines (e.g., based on feedback received from the network or receiver) that the receiver (e.g., gNB) requires X_{req,rec} NC PDUs to recover NC SDUs associated with an NC generation used to generate the NC PDUs and the WTRU (e.g., UE) determines that it has already submitted X_{¿} NC PDUs to lower layers, the WTRU (e.g., UE) may determine number of NC PDUs required to recover NC SDUs associated with the NC generation as X_{req}=└X_{req,rec}/R_{NC}┘−X_{¿} wherein R_{NC} is the NC code rate of the NC generation used to generate NC PDUs. According to certain embodiments, the WTRU (e.g., UE) may determine number of NC PDUs required to recover NC SDUs associated with the NC generation as X_{req}=┌X_{req,rec}/R_{NC}┐−X_{¿}.

According to certain embodiments, the WTRU (e.g., UE) may determine importance of an NC PDU based on any combination of the above.

For example, the WTRU (e.g., UE) may determine an NC PDU is of high importance if its remaining delay budget is below a threshold and the NC PDU is determined to be an NC PDU that counts towards the number of NC PDUs required at the receiver to recover the NC SDUs of the NC generation used to generate the NC PDUs, otherwise, the WTRU (e.g., UE) may determine the NC PDU is of low importance.

For example, the WTRU (e.g., UE) may determine an NC PDU is of high importance if the NC PDU counts towards the number of NC PDUs required at the receiver to recover the NC SDUs of the NC generation used to generate the NC PDUs, otherwise, the WTRU (e.g., UE) may determine the NC PDU is of low importance.

The WTRU (e.g., UE) may determine that an NC PDU counts towards the number of NC PDUs required at the receiver to recover the NC SDUs of the NC generation used to generate the NC PDUs, if it is an innovative NC PDU i.e. it is linearly independent of one or more NC PDUs, generated using the same NC generation, which the WTRU (e.g., UE) may have already transmitted (e.g., transmitted to the network but no negative acknowledgement is received, or determined by the WTRU (e.g., UE) as successfully received at the receiver based on positive acknowledgement received by the WTRU (e.g., UE) from the receiver), or submitted to lower layers buffers, or selected for submission to lower layers; and if X_{req}>0 that is the number of NC PDUs, generated from the NC generation, which are required to recover the NC SDUs associated with the NC generation are not already transmitted, or yet not selected for submission to lower layers.

According to certain embodiments, when NC operation and routing decision may be performed in the same node (e.g., a WTRU (e.g., UE)), the characteristics of NC PDUs may be visible to the transmit entity (e.g., L2/L1 layer) based on node implementation.

According to certain embodiments, when NC operation and routing decision may be performed at different nodes (e.g., in case of sidelink with a relay wherein routing of NC PDUs to different paths may be performed at an intermediate node), the characteristics of NC PDUs may be visible to the intermediate node based on any of the following: (1) signaling through user plane; or (2) signaling through control plane.

In the case of signaling through user plane, for example, PDU header carries information about characteristics of the NC PDU sent to the intermediate node. For example, a control PDU may be sent to the intermediate node with information on the upcoming NC PDUs so that the intermediate node becomes aware of the characteristics of the upcoming NC PDUs and can perform routing of those NC PDUs to different paths accordingly.

In the case of signaling through control plane, for example, RRC signaling may carry information about the upcoming NC PDUs for the intermediate node so that the intermediate node becomes aware of the characteristics of the upcoming NC PDUs and can perform routing of those NC PDUs to different paths accordingly. For example, intermediate node may have visibility of NC PDU characteristics carried over a path (e.g., bearer, flow etc.) via control plane signaling. When intermediate node receives an NC PDU on a path, it can implicitly know NC PDU characteristics to make routing decision for onward transmission on different paths.

The WTRU (e.g., UE) may determine one or more suitable paths (e.g., RLC entities) for transmission of NC PDUs based on one or more of link quality of paths, NC PDU characteristics, QoS requirements of NC PDUs, and PDCP lower layers configuration etc.]

According to certain embodiments, the WTRU (e.g., UE) may determine which paths (e.g., RLC entities) are suitable for transmission of an NC PDU as a function of one or more of the following: (1) link quality of path(s) between transmitter and receiver; (2) NC PDU characteristics e.g., type, importance, innovativeness, remaining delay budget etc.; or (3) PDCP lower layers configuration e.g., carrier type, cell group type, RLC mode of data transfer, grant attributes (e.g., NC PDU characteristics, MCS values, grant type etc.), mapping restrictions configured for the RLC entities (e.g., allowed MCS values, allowed grant type, allowed NC PDU characteristics etc.), RLC mode of data transfer etc.

Specifically, a WTRU (e.g., UE) may determine one or more suitable/preferred paths (e.g., RLC entities) to which WTRU (e.g., UE) may map an NC PDU based on one or any combination of the following: (1) pre-configured association between a characteristic of NC, NC configuration, and a set of paths; (2) WTRU (e.g., UE) autonomous determination of suitable path(s); or (3) information received in the header of NC PDU.

The WTRU (e.g., UE) may determine one or more suitable/preferred paths based on a re-configured association between a characteristic of NC PDU (e.g., type, innovativeness, remaining delay budget, importance etc.), NC configuration, and a set of paths (e.g., RLC entities) wherein a set of paths may comprise of one or more paths.

For example, the WTRU (e.g., UE) may be configured to map NC PDUs of a first characteristic (e.g., systematic, more innovative etc.), generated using an NC generation, to a first set of paths (e.g., RLC entities) and map NC PDUs of second characteristic (e.g., non-systematic, less innovative etc.) to a second set of paths (e.g., RLC entities).

For example, the WTRU (e.g., UE) may be configured to map NC PDUs with value/level of characteristic, e.g., remaining delay budget, importance etc., below a first threshold to a first set of paths (e.g., RLC entities) and map NC PDUs with value/level of characteristic (e.g., remaining delay budget, importance etc.) above a first threshold to a second set of paths (e.g., RLC entities).

For example, the WTRU (e.g., UE) may be configured to map NC PDUs generated using an NC generation with a first NC configuration to a first set of paths (e.g., RLC entities) and map NC PDUs generated using an NC generation with second NC configuration to a second set of paths (e.g., RLC entities).

The WTRU (e.g., UE) may determine one or more suitable/preferred paths based on a WTRU (e.g., UE) autonomous determination of suitable path(s) e.g., set of RLC entities, based on one or more of link quality, transmission latency, reliability (e.g., error rate) etc., to meet one or both of the following QoS requirements of an NC PDU: reliability and/or latency.

About reliability, according to certain embodiments, the WTRU (e.g., UE) may be configured with a primary path for data transmission and the WTRU (e.g., UE) may autonomously determine to find alternate/additional suitable path(s) from secondary paths, e.g., a set of RLC entities, which can transmit an NC PDU with higher reliability. For example, the WTRU (e.g., UE) may be configured with a primary path for data transmission and the WTRU (e.g., UE) may determine to route an NC PDU to a set of paths (e.g., RLC entities) configured for transmission with higher reliability if link condition on primary path is below a threshold. For example, the WTRU (e.g., UE) may determine to route an NC PDU with certain characteristics, e.g., systematic, more innovative etc., to a set of paths (e.g., RLC entities) configured for transmission with higher reliability if link condition on primary path is below a threshold.

According to certain embodiments, the WTRU (e.g., UE) may be configured with one or more set of paths and the WTRU (e.g., UE) may (e.g., always) determine which sets of paths are more reliable for transmission when routing NC PDUs with certain (pre)-configured characteristics, e.g., type, innovativeness, importance etc. For example, the WTRU (e.g., UE) may determine to route an NC PDU with remaining delay budget below a threshold or importance above a threshold to a set of paths (e.g., RLC entities) configured for transmission with highest reliability among all the configured sets of paths.

The WTRU (e.g., UE) may determine that a first set of paths, e.g., RLC entities, is more reliable than a second set of paths, e.g., RLC entities, if one or a combination of the following is satisfied: link quality for a first set of paths is better than a second set of paths; first set of paths is configured with lower layer (e.g., PDCP lower layer) configurations or radio resources which provide higher transmission reliability e.g., lower MCS values, larger number of repetitions etc. as compared to second set of paths.

About latency, according to certain embodiments, the WTRU (e.g., UE) may autonomously determine an NC PDU is to be routed to a set of suitable paths (e.g., RLC entities), to support lower transmission latency, in addition to or other than primary path. For example, the WTRU (e.g., UE) may be configured with a primary path for data transmission and the WTRU (e.g., UE) may determine to route an NC PDU to a set of alternate/additional paths (e.g., RLC entities) that can support latency requirement of NC PDU if delay on air interface on primary path is more than remaining delay budget of NC PDU or delay on air interface on primary path is more than a configured threshold. In another example, the WTRU (e.g., UE) may determine to route an NC PDU with remaining delay budget below a threshold to a set of more suitable paths (e.g., RLC entities), in addition to/other than primary path, which can support transmission with lower latency.

According to certain embodiments, the WTRU (e.g., UE) may be configured with one or more sets of paths and the WTRU (e.g., UE) may (e.g., always) determine which set of paths can support transmission with lower latency when routing NC PDUs with certain (pre)-configured characteristics, e.g., type, innovativeness, importance etc. For example, the WTRU (e.g., UE) may determine to route a systematic NC PDU or an NC PDU with remaining delay budget below a threshold or NC PDU with importance above a threshold to a set of paths (e.g., RLC entities) which can support low transmission latency among all the configured sets of paths.

According to certain embodiments, the WTRU (e.g., UE) may determine that a first set of paths (e.g., RLC entities) is more suitable than a second set of paths (e.g., RLC entities), to support latency requirement of NC PDUs e.g., based on their remaining delay budget, if one or a combination of the following is satisfied.

The WTRU (e.g., UE) may determine that a first set of paths (e.g., RLC entities) is more suitable than a second set of paths in the case where a link quality of paths for a first set of paths (e.g., RLC entities) is better than a second set of paths (e.g., RLC entities) which may reduce need for retransmissions and hence reduce the latency.

The WTRU (e.g., UE) may determine that a first set of paths (e.g., RLC entities) is more suitable than a second set of paths in the case where a buffer status of the RLC entities associated with first set of paths may result in transmission with lower latency than the second set of paths. For example, data volume (e.g., in bytes, bits, number of NC PDUs) in transmission buffer of RLC entities associated with first set of paths may be lower than the data volume in transmission buffer of RLC entities associated with second set of paths.

The WTRU (e.g., UE) may determine that a first set of paths (e.g., RLC entities) is more suitable than a second set of paths in the case where a remaining delay budget of the NC PDUs in the transmission buffer(s) associated with the first set of paths, e.g., the average/minimum remaining delay budget of NC PDUs in the RLC buffer associated with first path, is higher than the remaining delay budget of the NC PDU to be routed. Whereas remaining delay budget of the NC PDUs in the transmission buffer(s) associated with the second set of paths is lower than the remaining delay budget of the NC PDU to be routed.

The WTRU (e.g., UE) may determine that a first set of paths (e.g., RLC entities) is more suitable than a second set of paths in the case where a first set of paths (e.g., RLC entities) is configured with characteristics which may reduce transmission latency e.g., carrier type or cell group type that can offer lower delay on air interface, lower maximum PUSCH duration, multiple configured grant configurations with lower periodicity, different starting offsets to start a transmission etc. as compared to the second set of paths (e.g., RLC entities).

The WTRU (e.g., UE) may determine one or more suitable/preferred paths based on information received in the header of NC PDU. Specifically, when NC operation and routing decision may be performed at different nodes (e.g., in case of sidelink with a relay wherein routing of NC PDUs to different paths may be performed at an intermediate node), the intermediate node/WTRU (e.g., UE) may receive indication of characteristics of suitable paths for the NC PDU. Specifically, NC PDU header may carry information indicating the link quality (e.g., expected latency, threshold on distance to the BS, L1 or L3 measurement threshold etc.) expected for transmission of NC PDU.

For example, NC PDU header may carry information indicating the expected latency (minimum/maximum/average value, etc.) for a path to be considered as suitable path for transmission of NC PDU. For instance, if NC PDU header carries threshold on the maximum latency, the node will determine a path is suitable for routing the NC PDU if the maximum latency on the path is below or equal to the threshold. For instance, if NC PDU header carries threshold on the minimum latency, the node will determine a path to be is suitable for routing the NC PDU if the minimum latency on the path is above or equal to the threshold.

For example, NC PDU header may carry information indicating the distance (e.g., maximum number of hops) to the BS of a path for it to be considered suitable for transmission of NC PDU. If the number of hops on a path is less than or equal to the indicated value, the node will determine the path as a suitable path for routing the NC PDU.

For example, NC PDU header may carry information indicating a threshold for L1 or L3 measurement of a path that can be considered suitable for transmission of NC PDU. If the L1 or L3 measurement on a path is less than or equal to the indicated value, the node will determine the path as a suitable path for routing the NC PDU.

According to certain embodiments, the WTRU (e.g., UE) may determine that an NC PDU with a specific characteristic may be routed to all the suitable paths (e.g., RLC entities).

According to certain embodiments, the WTRU (e.g., UE) may determine an appropriate number of paths (e.g., RLC entities) out of suitable paths (e.g., RLC entities) based on QoS requirement of NC PDU.

According to certain embodiments, there may be a (pre)-configured association between one or more of NC PDU characteristic such as type, importance, remaining delay budget, required QoS level etc. and the number of suitable paths (e.g., RLC entities) to use. For example, the WTRU (e.g., UE) may be configured to route NC PDU with importance below a first threshold to one suitable path (e.g., RLC entity), route NC PDU with importance below a second threshold to two suitable paths (e.g., RLC entities) and route NC PDU with importance above a second threshold to three suitable paths (e.g., RLC entities) etc.

According to certain embodiments, the WTRU (e.g., UE) may autonomously determine (e.g., left for WTRU (e.g., UE) implementation) number of RLC entities to use out of suitable RLC entities for a required QoS level, NC PDU characteristic such as type, importance, remaining delay budget etc.

According to certain embodiments, the WTRU (e.g., UE) may determine an appropriate number of RLC entities out of suitable RLC entities based on information in the header of NC PDU. For example, when NC operation and routing decision may be performed at different nodes (e.g., in case of sidelink with a relay wherein routing of NC PDUs to different paths may be performed at an intermediate node), the intermediate node/WTRU (e.g., UE) may receive indication of how many paths the NC PDU may be mapped to in the NC PDU header.

Methods and procedures are provided for a WTRU (e.g., UE) to use one or more mechanisms for routing the NC PDUs generated using an NC generation to the suitable paths e.g., RLC entities. The WTRU (e.g., UE) may activate a specific mechanism for routing of NC PDUs either upon receiving an activation signaling from the gNB or autonomously based on pre-configured conditions.

Methods and procedures are provided for a (e.g., PDCP) routing mechanism for NC PDUs generated using an NC generation.

According to certain embodiments, a WTRU (e.g., UE) may use one or more combinations of the following mechanisms for mapping the NC PDUs generated using an NC generation to the suitable paths (e.g., RLC entities): (1) duplication mechanisms; (2) split mechanisms; or (3) selective mapping.

The duplication mechanisms may comprise rule based duplication wherein the WTRU (e.g., UE) may use a duplication rule based on one or more of the following characteristics of NC PDUs to determine mapping of NC PDUs generated using an NC generation to the suitable paths (e.g., RLC entities): (1) type of NC PDU; (2) innovativeness of NC PDUs; (3) remaining delay budget of NC PDUs; (4) delay budget of NC SDUs; or (5) importance of NC PDU.

Type of NC PDU may comprise, for example, systematic NC PDU, non-systematic NC PDU etc. For example, the WTRU (e.g., UE) may perform duplication of systematic NC PDUs generated using an NC generation whereas the WTRU (e.g., UE) may transmit non-systematic NC PDUs generated using an NC generation via single suitable path (e.g., RLC entity).

In the case of innovativeness of NC PDUs, for example, the WTRU (e.g., UE) may perform duplication of innovative NC PDUs generated using an NC generation whereas the WTRU (e.g., UE) may transmit non-innovative NC PDUs generated using an NC generation via single suitable path (e.g., RLC entity). For example, the WTRU (e.g., UE) may perform duplication of more-innovative NC PDUs generated using an NC generation whereas the WTRU (e.g., UE) may transmit less-innovative NC PDUs generated using an NC generation via single suitable path (e.g., RLC entity).

In the case of remaining delay budget of NC PDUs, for example, the WTRU (e.g., UE) may perform duplication of NC PDUs with low remaining delay budget (e.g., below a threshold) whereas the WTRU (e.g., UE) may transmit NC PDUs with high remaining delay budget (e.g., above a threshold) via single suitable path (e.g., RLC entity).

Delay budget of NC SDUs may comprise the required latency for recovery of NC SDUs associated with the NC generation used to generate NC PDUs. For example, the WTRU (e.g., UE) may perform duplication of NC PDUs if the remaining delay budget of the NC SDUs associated with the NC generation used to generate the NC PDUs is low (e.g., below a threshold) whereas the WTRU (e.g., UE) may transmit NC PDUs via single suitable path (e.g., RLC entity) if the remaining delay budget of the NC SDUs associated with the NC generation used to generate the NC PDUs is high (e.g., above a threshold).

Importance of NC PDU may be as defined in the description above. For example, the WTRU (e.g., UE) may perform duplication of NC PDUs with high importance (e.g., importance above a threshold) whereas the WTRU (e.g., UE) may transmit NC PDUs with low importance (e.g., importance below a threshold) via single suitable path (e.g., RLC entity).

The duplication mechanisms may comprise NC PDU volume based-duplication wherein the WTRU (e.g., UE) may perform duplication of X+Xₙ, wherein Xₙ may be positive or negative integer, NC PDUs generated using an NC generation. Whereas the WTRU (e.g., UE) may transmit remaining Y−X−Xₙ NC PDUs generated using the NC generation via single suitable path (e.g., RLC entity).

The split mechanisms may comprise rule based split wherein the WTRU (e.g., UE) may map one or more NC PDUs generated using an NC generation to different paths (e.g., RLC entities) based on one or more of the following: (1) type of NC PDU; (2) innovativeness of NC PDUs; (3) remaining delay budget of NC PDUs; (4) delay budget of NC SDUs; or (5) importance of NC PDU.

Type of NC PDU may comprise, for example, systematic NC PDU, non-systematic NC PDU etc. For example, the WTRU (e.g., UE) may map systematic NC PDUs, generated using an NC generation, to a first path (e.g., RLC entity) and the WTRU (e.g., UE) may map non-systematic NC PDUs, generated using an NC generation, to a second path (e.g., RLC entity).

In the case of innovativeness of NC PDUs, for example, the WTRU (e.g., UE) may map innovative NC PDUs, generated using an NC generation, to a first path (e.g., RLC entity) and the WTRU (e.g., UE) may map non-innovative NC PDUs, generated using an NC generation, to a second path (e.g., RLC entity). For example, the WTRU (e.g., UE) may map more-innovative NC PDUs, generated using an NC generation, to a first path (e.g., RLC entity) and the WTRU (e.g., UE) may map less-innovative NC PDUs, generated using an NC generation, to a second path (e.g., RLC entity).

In the case of remaining delay budget of NC PDUs, for example, the WTRU (e.g., UE) may map NC PDUs with low remaining delay budget (e.g., below a threshold) to a first path (e.g., RLC entity) whereas the WTRU (e.g., UE) may transmit NC PDUs with high remaining delay budget (e.g., above a threshold) via a second path (e.g., RLC entity).

Delay budget of NC SDUs may comprise the required latency for recovery of NC SDUs associated with the NC generation used to generate NC PDUs. For example, the WTRU (e.g., UE) may route NC PDUs to a first path (e.g., RLC entity) if the remaining delay budget of the NC SDUs associated with the NC generation used to generate the NC PDUs is low (e.g., below a threshold) whereas the WTRU (e.g., UE) may transmit NC PDUs via second path (e.g., RLC entity) if the remaining delay budget of the NC SDUs associated with the NC generation used to generate the NC PDUs is high (e.g., above a threshold).

Importance of NC PDU may be as defined in the description above. For example, the WTRU (e.g., UE) may map NC PDUs, generated using an NC generation, with higher importance (e.g., higher than a first threshold) to a first path (e.g., RLC entity) and the WTRU (e.g., UE) may map NC PDUs, generated using an NC generation, of lower importance (e.g., lower than a first threshold) to second path (e.g., RLC entity).

The split mechanisms may comprise NC PDUs volume-based split wherein the WTRU (e.g., UE) may be (pre)-configured to map Xₜₕᵣ NC PDUs generated using an NC generation to first path (e.g., RLC entity) whereas the WTRU (e.g., UE) may transmit remaining Y−Xₜₕᵣ NC PDUs via a second path (e.g., RLC entity). According to certain embodiments, the WTRU (e.g., UE) may autonomously determine the threshold to determine the NC PDUs. The WTRU (e.g., UE) may transmit across different paths (e.g., RLC entities).

Selective mapping may comprise a hybrid mapping method wherein the WTRU (e.g., UE) may transmit a first set of NC PDUs generated using an NC generation via first set of paths (e.g., RLC entities) while the WTRU (e.g., UE) may transmit a second set of NC PDUs generated using an NC generation via a second set of paths (e.g., RLC entities) wherein a set of paths (e.g., RLC entities) consists of one or more paths (e.g., RLC entities). In this mechanism, a first set of paths (e.g., RLC entities) does not fully overlap with a second set of paths (e.g., RLC entities) or vice versa (i.e., there is at least one mutually exclusive path (e.g., RLC entity) associated with each set of paths). The WTRU (e.g., UE) may (e.g., further) perform duplication of the NC PDUs from first set of NC PDUs among the paths (e.g., RLC entities) forming the first set of paths (e.g., RLC entities) and the WTRU (e.g., UE) may perform duplication of the NC PDUs from second set of NC PDUs among the paths (e.g., RLC entities) forming the second set of paths (e.g., RLC entities).

Methods and procedures are provided for activation of (e.g., PDCP) routing mechanism for NC PDUs generated using an NC generation.

Methods and procedures are provided for allowing the WTRU (e.g., UE) to determine (e.g., PDCP) routing method for NC PDUs generated using an NC generation based on indication from the base station.

According to certain embodiments, a WTRU (e.g., UE) may determine to activate a (e.g., PDCP) routing mechanism based on an activation signalling or configuration received from the network. The WTRU (e.g., UE) may determine which routing mechanism to use for mapping of NC PDUs generated using an NC generation based on one or more of the following: (1) configuration of a specific (e.g., PDCP) routing mechanism from the base station; (2) an activation signaling for (e.g., PDCP) routing mechanism; (3) configuration of RLC entities; (4) activation of RLC entities; or (5) activation of an NC configuration.

In the case of a configuration of a specific (e.g., PDCP) routing mechanism from the base station, for example, a WTRU (e.g., UE) may be configured with one (e.g., PDCP) routing mechanism for NC PDUs via RRC signaling. The WTRU (e.g., UE) may determine the configured (e.g., PDCP) routing mechanism is active upon reception of RRC configuration and the WTRU (e.g., UE) may map NC PDUs to paths (e.g., RLC entities) based on the configured (e.g., PDCP) routing mechanism.

In the case of an activation signaling for (e.g., PDCP) routing mechanism, for example, the WTRU (e.g., UE) may be configured with one or more (e.g., PDCP) routing mechanisms for NC PDUs. The WTRU (e.g., UE) may (e.g., further) receive a control signaling (e.g., MAC CE or another control PDU, DCI etc.) from base station which may indicate to the WTRU (e.g., UE) to activate a specific (e.g., PDCP) routing mechanism for NC PDUs.

In the case of a configuration of RLC entities, for example, the WTRU (e.g., UE) may be configured with a (e.g., PDCP) routing mechanism and the WTRU (e.g., UE) may (e.g., further) receive RRC signaling configuring one or more RLC entities for a PDCP entity. The WTRU (e.g., UE) may determine configured (e.g., PDCP) routing mechanism for NC PDUs is activated upon receiving the configuration signaling for one or more RLC entities.

In the case of an activation of RLC entities, for example, the WTRU (e.g., UE) may be configured with a (e.g., PDCP) routing mechanism and a set of suitable RLC entities may be required for the routing of NC PDUs using the configured mechanism. The WTRU (e.g., UE) may (e.g., further) receive an activation signaling from the network activating the set of suitable RLC entities wherein a set may have one or more RLC entities. The WTRU (e.g., UE) may determine the (e.g., PDCP) routing mechanism for NC PDUs is activated upon reception of signaling from the network activating the set of suitable RLC entities. For example, the WTRU (e.g., UE) may be configured with a set of suitable RLC entities for routing of NC PDUs. The WTRU (e.g., UE) may (e.g., further) receive NC PDU set-specific activation signaling activating one or more RLC entities for carrying the NC PDUs from a specific set where the NC PDU set carries NC PDUs with specific characteristics. For example, the WTRU (e.g., UE) may duplicate the NC PDUs belonging to the NC PDU set for which the activation signaling is transmitted over the activated RLC entities. In another example, the WTRU (e.g., UE) may split the NC PDUs belonging to the NC PDU set for which the activation signaling is transmitted over the activated RLC entities.

In the case of an activation of an NC configuration, for example, the WTRU (e.g., UE) may be configured with one or more (e.g., PDCP) routing mechanisms, a set of NC configurations and a mapping between NC configurations and (e.g., PDCP) routing mechanisms. The WTRU (e.g., UE) may (e.g., further) receive an activation signaling from the network activating an NC configuration. The WTRU (e.g., UE) may determine the associated (e.g., PDCP) routing mechanism for NC PDUs is activated upon reception of signaling form the network activating the NC configuration. According to certain embodiments, the WTRU (e.g., UE) may autonomously activate an NC configuration based on pre-configured conditions. The WTRU (e.g., UE) may determine the associated (e.g., PDCP) routing mechanism for NC PDUs is activated upon activation of the NC configuration.

Methods and procedures are provided for allowing the WTRU (e.g., UE) to determine autonomously which method to use for routing of NC PDUs.

According to certain embodiments, the WTRU (e.g., UE) may be (pre)-configured with one or more (e.g., PDCP) routing mechanisms for NC PDUs and the WTRU (e.g., UE) may autonomously determine to use one or more of the (e.g., PDCP) routing mechanisms. Specifically, a WTRU (e.g., UE) may be (pre)-configured with rules or conditions to determine which mechanism to use for mapping of NC PDUs generated using an NC generation to the suitable paths (e.g., RLC entities). The WTRU (e.g., UE) may be (pre)-configured with conditions for use of (e.g., PDCP) routing mechanisms based on one or more of the following: (1) radio conditions; (2) NC code rate; (3) lower layers (e.g., RLC or layers below RLC layer) configurations; (4) latency requirement of NC PDUs; or (5) required latency for recovery of NC SDUs associated with the NC generation used to generate NC PDUs.

Radio conditions may comprise link quality based on radio measurements, transmission delay on the air interface, another proxy metrics such as success ratio of NC PDUs transmission, number of L2/L1 retransmissions, etc. of a primary path and/or other paths (e.g., RLC entities).

According to certain embodiments, the WTRU (e.g., UE) may use a first (e.g., PDCP) routing method (pre)-configured for NC PDUs if the WTRU (e.g., UE) determines that a link quality of the air interface on a primary and/or other path is equal or below a threshold. Otherwise, the WTRU (e.g., UE) may use a second (e.g., PDCP) routing method to map NC PDUs to one or more suitable paths (e.g., RLC entities). For example, if the link quality is equal or below a configured threshold, the WTRU (e.g., UE) may determine to use a mechanism wherein the WTRU (e.g., UE) may perform duplication of NC PDUs e.g., rule based duplication, selective mapping etc. to enhance reliability of NC PDU transmission. Otherwise, according to certain embodiments, the WTRU (e.g., UE) may use a split mechanism to map the NC PDUs to suitable paths (e.g., RLC entities). According to certain embodiments, the WTRU (e.g., UE) may map NC PDUs to primary path or another single suitable path (e.g., RLC entity) if link quality is equal or above a configured threshold.

According to certain embodiments, the WTRU (e.g., UE) may use a first (e.g., PDCP) routing method (pre)-configured for NC PDUs if transmission delay on the air interface on primary and/or other suitable paths is equal or above a threshold. Otherwise, the WTRU (e.g., UE) may use a second (e.g., PDCP) routing method to map NC PDUs to one or more suitable paths (e.g., RLC entities). For example, if transmission delay (e.g., based on WTRU (e.g., UE) location etc.) on air interface is equal or above a configured threshold, the WTRU (e.g., UE) may determine to use a split mechanism e.g., rule based split, selective mapping etc. wherein NC PDUs generated using one or more NC generations are transmitted via two or more suitable paths (e.g., RLC entities) to support recovery of NC SDUs associated with an NC generation within a certain delay bound. Otherwise, according to certain embodiments, the WTRU (e.g., UE) may use a mechanism wherein WTRU (e.g., UE) may perform duplication of NC PDUs across two or more suitable paths (e.g., RLC entities). According to certain embodiments, the WTRU (e.g., UE) may map NC PDUs to single suitable path or primary path if transmission delay is equal or below a configured threshold.

In the case of conditions for use of (e.g., PDCP) routing mechanisms based on NC code rate, the WTRU (e.g., UE) may use a first (e.g., PDCP) routing method (pre)-configured for NC PDUs if NC code rate of the NC generation used to generate NC PDUs is equal or above a threshold. Otherwise, the WTRU (e.g., UE) may use a second (e.g., PDCP) routing method to map NC PDUs to one or more suitable paths (e.g., RLC entities). For example, if NC code rate is equal or above a configured threshold, the WTRU (e.g., UE) may determine to use a mechanism wherein WTRU (e.g., UE) may perform duplication of NC PDUs e.g., rule based duplication, selective mapping etc. to enhance reliability of NC PDU transmission. Otherwise, the WTRU (e.g., UE) may use a split mechanism to map the NC PDUs to suitable paths (e.g., RLC entities). According to certain embodiments, the WTRU (e.g., UE) may map NC PDUs to single path (e.g., RLC entity) if NC code rate is equal or below a configured threshold.

In the case of conditions for use of (e.g., PDCP) routing mechanisms based on lower layers (e.g., RLC or layers below RLC layer) configurations, it may comprise a number of RLC entities, mode of data transmission etc.

According to certain embodiments, the WTRU (e.g., UE) may use a first (e.g., PDCP) routing method (pre)-configured for NC PDUs if number of paths (e.g., RLC entities) available for transmission of NC PDUs is equal or above a threshold. Otherwise, the WTRU (e.g., UE) may use a second (e.g., PDCP) routing method to map NC PDUs to one or more suitable paths (e.g., RLC entities). For example, if number of RLC entities available for transmission of NC PDUs is equal or above a configured threshold, the WTRU (e.g., UE) determines to use a mechanism wherein the WTRU (e.g., UE) may use e.g., selective mapping to reduce transmission latency and/or enhance reliability of NC PDU transmission. Otherwise, the WTRU (e.g., UE) may use a split mechanism e.g., rule based split etc. to map the NC PDUs to suitable RLC entities. According to certain embodiments, the WTRU (e.g., UE) may use a duplication mechanism to map NC PDUs to RLC entities if number of suitable RLC entities available for transmission of NC PDUs is equal or below a configured threshold.

According to certain embodiments, the WTRU (e.g., UE) may use a first (e.g., PDCP) routing method (pre)-configured for NC PDUs if paths (e.g., RLC entities) available for transmission of NC PDUs are configured with first mode of data transfer. Otherwise, if paths (e.g., RLC entities) available for transmission of NC PDUs are configured with second mode of data transfer, the WTRU (e.g., UE) may use a second (e.g., PDCP) routing method to map NC PDUs to one or more RLC entities. For example, if transmission mode for available RLC entities is acknowledged mode (AM), the WTRU (e.g., UE) may determine to use a split mechanism e.g., rule based split, selective mapping etc. wherein NC PDUs generated using one or more NC generations are transmitted via two or more RLC entities. Otherwise, the WTRU (e.g., UE) may use a mechanism wherein the WTRU (e.g., UE) may perform duplication of NC PDUs across two or more suitable RLC entities.

According to certain embodiments, the WTRU (e.g., UE) may use a first (e.g., PDCP) routing method (pre)-configured for NC PDUs if one set of RLC entities available for transmission of NC PDUs is configured with first set of configurations and second set of RLC entities available for transmission of NC PDUs is configured with second set of configurations. Otherwise, if set of RLC entities available for transmission of NC PDUs is configured with third set of configurations, the WTRU (e.g., UE) may use a second (e.g., PDCP) routing method to map NC PDUs to one or more RLC entities. For example, if a first set of RLC entities available for transmission of NC PDUs is configured with first set of configurations and second set of RLC entities available for transmission of NC PDUs is configured with second set of configurations wherein first set of configurations provide higher transmission reliability than the second set of configurations, the WTRU (e.g., UE) may determine to use a split mechanism e.g., rule based split, selective mapping etc. for routing of NC PDUs. Otherwise, the WTRU (e.g., UE) may use a duplication mechanism or NC PDU volume-based split for routing of NC PDUs.

In the case of conditions for use of (e.g., PDCP) routing mechanisms based on latency requirement of NC PDUs, for example, the WTRU (e.g., UE) may use a first (e.g., PDCP) routing method (pre)-configured for mapping NC PDUs to suitable paths (e.g., RLC entities) if remaining delay budget of NC PDUs is equal or below a threshold. Otherwise, the WTRU (e.g., UE) may use a second (e.g., PDCP) routing method to map NC PDUs to one or more suitable paths (e.g., RLC entities). Specifically, if remaining delay budget of NC PDUs is equal or below a configured threshold, the WTRU (e.g., UE) may determine to use a split mechanism e.g., rule based split, selective mapping etc. wherein NC PDUs generated using one or more NC generations are transmitted via two or more suitable paths (e.g., RLC entities) to support reception of NC PDUs within a certain delay bound. Otherwise, the WTRU (e.g., UE) may use a mechanism wherein the WTRU (e.g., UE) may perform duplication of NC PDUs across two or more suitable paths (e.g., RLC entities). According to certain embodiments, the WTRU (e.g., UE) may map NC PDUs to single suitable path (e.g., RLC entity) if remaining delay budget of NC PDUs is equal or above a configured threshold.

In the case of conditions for use of (e.g., PDCP) routing mechanisms based on required latency for recovery of NC SDUs associated with the NC generation used to generate NC PDUs, for example, the WTRU (e.g., UE) may use a first (e.g., PDCP) routing method (pre)-configured for mapping NC PDUs to suitable paths (e.g., RLC entities) if required latency to recover NC SDUs associated with the NC generation used to generate NC PDUs is equal or below a threshold. Otherwise, the WTRU (e.g., UE) may use a second (e.g., PDCP) routing method to map NC PDUs to one or more suitable paths (e.g., RLC entities). Specifically, if required latency to recover NC SDUs associated with the NC generation used to generate NC PDUs is equal or below a configured threshold, the WTRU (e.g., UE) may determine to use a split mechanism e.g., rule based split, selective mapping etc. wherein NC PDUs generated using the NC generations are transmitted via two or more suitable paths (e.g., RLC entities) to support recovery of NC SDUs associated with the NC generation within a certain delay bound. Otherwise, the WTRU (e.g., UE) may use a mechanism wherein the WTRU (e.g., UE) may perform duplication of NC PDUs across two or more suitable paths (e.g., RLC entities). According to certain embodiments, the WTRU (e.g., UE) may map NC PDUs to single suitable path (e.g., RLC entity) if required latency to recover NC SDUs associated with the NC generation used to generate NC PDUs is equal or above a configured threshold.

Methods and procedures are provided for allowing the WTRU (e.g., UE) to route NC PDUs to one or more suitable paths, e.g., RLC entities, as a function of one or more of link quality, importance of NC PDUs, NC configuration and PDCP lower layers configuration etc.

According to certain embodiments, the WTRU (e.g., UE) may determine how to map an NC PDU generated using an NC generation to available paths e.g., RLC entities based on the activated (e.g., signalled by the gNB or selected by the WTRU (e.g., UE)) (e.g., PDCP) routing mechanism and/or the associated NC related conditions which may be a function of one or more of the following factors: (1) link quality between transmitter and receiver; (2) NC PDU characteristics e.g., type, importance, innovativeness etc.; (3) NC PDU transmission attempt e.g., first transmission or retransmission; (4) NC SDU transmission attempt e.g., first transmission or retransmission; (5) NC PDU volume threshold e.g., (pre)-configured or determined by the WTRU (e.g., UE); (6) NC code rate of the NC generation; or (7) lower layers configuration e.g., carrier type, cell group type, RLC mode of data transfer, allowed grant attributes (e.g., NC PDU characteristics, MCS values, grant type etc.) configured for the RLC entities etc.

In the case of the WTRU (e.g., UE) determining how to route the NC PDU to suitable paths, e.g., RLC entities, based on the link quality between transmitter and receiver, for example, the WTRU (e.g., UE) may determine to use selective mapping mechanism for (e.g., PDCP) routing of NC PDUs, generated using an NC generation, and the WTRU (e.g., UE) may (e.g., further) determine whether to perform duplication of a set of NC PDUs (wherein the NC PDUs in a set of NC PDUs may be of the same characteristic e.g., type, innovativeness, importance etc.) among a set of suitable paths (e.g., RLC entities) based on link quality between transmitter and receiver. For example, if link quality on one or more paths is below a threshold, the WTRU (e.g., UE) may duplicate NC PDU from first set of NC PDUs across the suitable paths in a first set of paths (e.g., RLC entities) and the WTRU (e.g., UE) may duplicate NC PDU from second set of NC PDUs across the suitable paths in a second set of paths (e.g., RLC entities). Otherwise, the WTRU (e.g., UE) map duplicate NC PDUs from first set of NC PDUs across the suitable paths in a first set of paths (e.g., RLC entities) and the WTRU (e.g., UE) may map NC PDUs from a second set of NC PDUs to one suitable path from the second set of paths (e.g., RLC entities).

For example, if the WTRU (e.g., UE) determines that channel condition (e.g., based on radio measurement etc.) on the available paths is above a threshold (i.e. good channel condition), the WTRU (e.g., UE) may map NC PDUs of a first set of NC PDUs (e.g., NC PDUs with high importance or importance above a threshold) to one or more paths (e.g., RLC entities) associated with a first set of lower layers configuration whereas the WTRU (e.g., UE) may map NC PDUs of a second set of NC PDUs (e.g., NC PDUs with low importance or importance below a threshold) to one or more paths (e.g., RLC entities) associated with a second set of lower layers configuration, wherein the first set of lower layers configuration provide higher transmission reliability than the second set of configuration e.g., via higher number of configured grant repetitions, aggregation factor, a first set of (e.g., lower order) MCS values etc. Otherwise, (i) according to certain embodiments, the WTRU (e.g., UE) may map all NC PDUs to one or more paths (e.g., RLC entities) configured with a third set of lower layers configuration wherein third set of lower layers configuration provide higher transmission reliability than the first set and second set of configurations. (ii) according to certain embodiments, the WTRU (e.g., UE) may map all NC PDUs to one or more paths (e.g., RLC entities) configured with a first set of lower layers configuration.

In the case of the WTRU (e.g., UE) determining how to route the NC PDU to suitable paths, e.g., RLC entities, based on NC PDU characteristics (e.g., type, importance, innovativeness etc.), for example, the WTRU (e.g., UE) may determine to activate a mechanism which supports duplication (such as selective mapping, rule-based duplication etc.) of NC PDUs e.g., due to poor radio conditions on primary and/or other paths. The WTRU (e.g., UE) may (e.g., further) be configured to or determine whether to perform duplication of an NC PDU based on one or more of its characteristics e.g., type, importance, innovativeness etc. Specifically, the WTRU (e.g., UE) may duplicate an NC PDU across two or more suitable paths (e.g., RLC entities) if the NC PDU is e.g., systematic, more-innovative, has high importance etc. Whereas the WTRU (e.g., UE) may route an NC PDU to one suitable path (e.g., RLC entity) if the NC PDU is e.g., non-systematic, less-innovative, has low importance etc.

For example, the WTRU (e.g., UE) may receive indication to activate split mechanism. If NC PDU is of first type (e.g., systematic NC PDU, more innovative etc.), the WTRU (e.g., UE) may transmit NC PDU via a first set of one or more paths with better link quality (e.g., based on radio measurement) than a second set of paths. Otherwise, the WTRU (e.g., UE) may transmit NC PDU of second type (e.g., non-systematic NC PDU) via second set of paths.

In the case of the WTRU (e.g., UE) determining how to route the NC PDU to suitable paths (e.g., RLC entities), based on NC PDU transmission attempt e.g., first transmission or retransmission, for example, the WTRU (e.g., UE) may determine to activate a mechanism which supports duplication of NC PDUs (e.g., due to poor radio conditions) and the WTRU (e.g., UE) may (e.g., further) determine whether to perform duplication based on whether the WTRU (e.g., UE) is retransmitting the NC PDU or not. Specifically, the WTRU (e.g., UE) may duplicate NC PDUs if they are being retransmitted. Otherwise, the WTRU (e.g., UE) may not duplicate NC PDUs across multiple paths (e.g., RLC entities).

For example, the WTRU (e.g., UE) may perform initial transmission of an NC PDU via one or more suitable paths, e.g., RLC entities, configured with first set of lower layer configurations. Whereas the WTRU (e.g., UE) may perform retransmission of NC PDU via a set of suitable paths (e.g., RLC entities) configured with second set of lower layer configurations wherein second set of lower layer configurations may provide higher transmission reliability than the first set of lower layer configurations.

In the case of the WTRU (e.g., UE) determining how to route the NC PDU to suitable paths, e.g., RLC entities, based on NC SDU transmission attempt (e.g., first transmission or retransmission), for example, the WTRU (e.g., UE) may determine to activate a mechanism which supports duplication of NC PDUs (e.g., due to poor radio conditions on primary and/or other paths) and WTRU (e.g., UE) may (e.g., further) determine whether to perform duplication based on whether one or more NC SDUs, associated with the NC generation used to generate the NC PDU, are being retransmitted or not. Specifically, the WTRU (e.g., UE) may duplicate NC PDUs if they are generated using an NC generation comprising of one or more NC SDUs which are being retransmitted.

For example, if one or more NC SDUs associated with the NC generation used to generate the NC PDU are being retransmitted, the WTRU (e.g., UE) may route the NC PDUs to one or more suitable paths, e.g., RLC entities, configured with first set of lower layer configurations. Otherwise, the WTRU (e.g., UE) may route the NC PDUs to one or more suitable paths, e.g., RLC entities, configured with second set of lower layer configurations wherein second set of lower layer configurations may provide lower transmission reliability than the first set of lower layer configurations.

In the case of the WTRU (e.g., UE) determining how to route the NC PDU to suitable paths (e.g., RLC entities), based on NC PDU volume threshold e.g., (pre)-configured by the network or determined by the WTRU (e.g., UE), for example, the WTRU (e.g., UE) may determine to activate a mechanism which supports duplication (such as selective mapping, rule-based duplication etc.) of NC PDUs e.g., due to poor radio conditions on primary and/or other paths. The WTRU (e.g., UE) may duplicate X +Xₙ NC PDUs out of, e.g., Y NC PDUs generated using an NC generation across suitable paths, e.g., RLC entities, whereas the WTRU (e.g., UE) may map Y−X−Xₙ NC PDUs generated using the NC generation to single suitable path e.g., RLC entity.

For example, the WTRU (e.g., UE) may determine to activate a split mechanism to transmit NC PDUs generated using an NC generation via different sets of paths (e.g., RLC entities) e.g., to meet delay budget requirement of the NC generation used to generate NC PDUs. The WTRU (e.g., UE) may route Xₜₕᵣ NC PDUs out of, e.g., Y NC PDUs generated using an NC generation to first set of suitable paths, e.g., RLC entities, whereas the WTRU (e.g., UE) may route Y−Xₜₕᵣ NC PDUs generated using the NC generation to second set of suitable paths e.g., RLC entities. First set of paths may provide transmission with higher reliability (e.g., better link quality, configured with data transmission for higher reliability such as lower order MCS etc.) than the second set of paths or vice versa.

In the case of the WTRU (e.g., UE) determining how to route the NC PDU to suitable paths, e.g., RLC entities, based on NC code rate of the NC generation, for example, the WTRU (e.g., UE) may determine to activate a mechanism which supports duplication (such as selective mapping, rule-based duplication etc.) of NC PDUs e.g., due to poor radio conditions on primary and/or other paths. The WTRU (e.g., UE) may (e.g., further) determine whether to perform duplication based on NC code rate of the generation used for generating NC PDU. For instance, the WTRU (e.g., UE) may duplicate an NC PDU across the suitable paths, e.g., RLC entities, if NC code rate of the generation used to generate the NC PDU is above a threshold. Otherwise, the WTRU (e.g., UE) may map NC PDU to only one suitable path (e.g., RLC entity).

For example, the WTRU (e.g., UE) may determine to activate a split mechanism (such as selective mapping, rule-based split etc.) e.g., due to large transmission delay on primary and/or other available paths. The WTRU (e.g., UE) may (e.g., further) determine to map NC PDUs generated using an NC generation to one or more paths, e.g., RLC entities, based on code rate of NC generation used to generate NC PDUs. Specifically, if NC code rate of an NC generation used to generate NC PDUs is below a threshold, the WTRU (e.g., UE) may map NC PDUs to a first set of paths (e.g., RLC entities). Otherwise, if code rate of NC generation used to generate NC PDUs is above a threshold, the WTRU (e.g., UE) may map NC PDUs to a second set of paths (e.g., RLC entities) wherein the second set of RLC entities may be configured with lower layer configurations which may provide higher transmission reliability than the lower layer configuration configured for the first set of RLC entities.

For example, if NC code rate of an NC generation used to generate NC PDUs is below a threshold, the WTRU (e.g., UE) may map a first set of NC PDUs (e.g., NC PDUs with high importance) to one or more paths associated with a first set of lower layers configuration whereas WTRU (e.g., UE) may map second set of NC PDUs (e.g., NC PDUs with low importance) to one or more paths associated with a second set of lower layers configuration, wherein the first set of lower layers configuration may provide higher transmission reliability than the second set of configuration. Otherwise, (i) according to certain embodiments, the WTRU (e.g., UE) may map all NC PDUs to one or more suitable paths, e.g., RLC entities, configured with a third set of lower layers configuration wherein third set of lower layers configuration provide higher transmission reliability than the first set and second set of configurations. (ii) According to certain embodiments, the WTRU (e.g., UE) may map all NC PDUs to one or more suitable paths configured with a first set of lower layers configuration

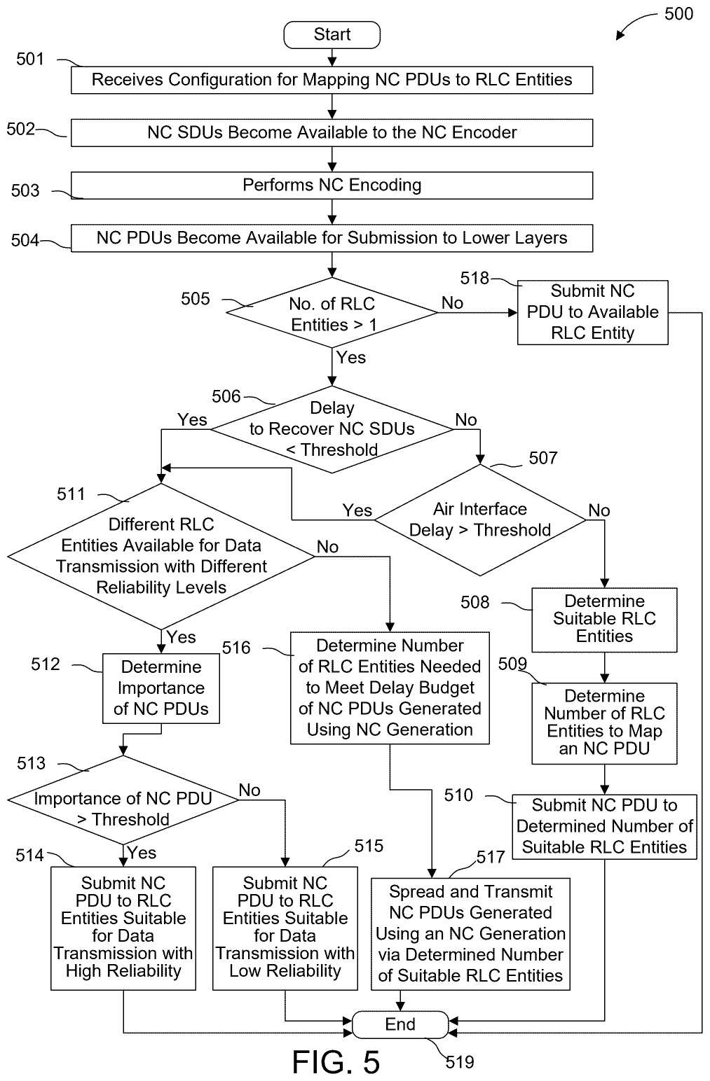

Following is an example of a method 500 of WTRU (e.g., UE) processing (as shown in FIG. 5) to determine how to route an NC PDU to RLC entities as a function of one or more of NC PDU importance criteria and characteristics of the path associated with each RLC entity e.g., carrier type, cell group, allowed grant attributes (e.g., MCS values, grant type etc.), mode of data transfer of RLC entity etc.

In step 501, the WTRU (e.g., UE) may receive configuration information.

The configuration information may comprise criteria to determine importance of NC PDU as a function of one or more of the remaining delay budget of NC PDU, level of innovativeness, type of NC PDU, importance of NC SDU(s) associated with the NC generation used to generate the NC PDU and number of NC PDUs required to recover NC SDUs forming the NC generation used to generate the NC PDU etc.

The configuration information may comprise conditions for routing NC PDUs to RLC entities as a function of importance of NC PDUs, remaining delay budget, NC configuration and path characteristics.

In step 502, 503 & 504: Upon arrival of NC SDUs in the buffer, the WTRU (e.g., UE) may perform NC encoding and NC PDUs become available for submission to lower layers i.e., RLC entities.

In step 505: If multiple RLC entities are available for transmission of NC PDUs, the method may go to step 506. Otherwise, the method may go to step 518.

In step 506: If delay budget to recover NC SDUs associated with the NC generation used to generate NC PDUs is less than a threshold, the method may go to step 511. Otherwise, the method may go to step 507.

In step 507: If delay on air interface for transmission of NC PDUs on primary path (e.g., RLC entity) is greater than a threshold, the method may go to step 511. Otherwise, the method may go to step 508.

In step 508: the WTRU (e.g., UE) may determine one or more suitable paths or RLC entities for transmission of NC PDUs based on one or more of link quality, NC PDU characteristics, QoS requirements of NC PDUs and PDCP lower layers configuration etc. as described above.

In step 509: the WTRU (e.g., UE) may determine number of suitable RLC entities required for transmission of an NC PDU, e.g., based on one or more of NC PDU characteristic such as type, importance, remaining delay budget, required QoS level etc., as described above.

In step 510: the WTRU (e.g., UE) may submit NC PDU to the required number of suitable RLC entities for transmission to the receiver. The method may go to step 519.

In step 511: If different RLC entities, available for NC PDUs transmission, are configured with configurations for data transmission with different reliability levels, the method may go to step 512. Otherwise, the method may go to step 516.

In step 512: the WTRU (e.g., UE) may determine importance of NC PDU as a function of one or more of the remaining delay budget of NC PDU, level of innovativeness, type of NC PDU, importance of NC SDU(s) associated with the NC generation used to generate the NC PDU and number of NC PDUs required (denoted herein as X_{req}) to recover NC SDUs forming the NC generation used to generate the NC PDU. E.g., an NC PDU is of higher importance if remaining delay budget is below a threshold and, the NC PDU is determined to be an NC PDU that counts towards the number of NC PDUs required at the receiver to recover the NC SDUs of the NC generation used to generate the NC PDUs, otherwise the NC PDU is of lower importance. The WTRU (e.g., UE) may determine that an NC PDU counts towards the number of NC PDUs required at the receiver to recover the NC SDUs of the NC generation used to generate the NC PDUs, if it is an innovative NC PDU i.e. it is linearly independent of one or more NC PDUs, generated using the same NC generation, which the WTRU (e.g., UE) may have already transmitted (e.g., transmitted to the gNB but no negative acknowledgement is received, or determined by the WTRU (e.g., UE) as successfully received at the receiver based on positive acknowledgement received by the WTRU (e.g., UE) from the receiver), or submitted to lower layers buffers, or selected for submission to lower layers; and if less than X_{req} NC PDUs generated from the NC generation are already transmitted, or selected for submission to lower layers.

In step 513: If importance of NC PDU is high, the method may go to step 14. Otherwise, the method may go to step 515.

In step 514: the WTRU (e.g., UE) may submit NC PDU to a first set of suitable RLC entities with path characteristics that can support data with high reliability. The method may go to step 519.

In step 515: the WTRU (e.g., UE) may submit NC PDU to second set of suitable RLC entities with path characteristics that can support data with lower reliability as compared to first set of RLC entities. The method may go to step 519.

In step 516: For NC PDUs, generated using an NC generation, the WTRU (e.g., UE) may determine the number of sets of RLC entities used (e.g., needed) for transmission of NC PDUs to meet the remaining delay budget requirement of NC PDUs.

In step 517: the WTRU (e.g., UE) may submit different sets of NC PDUs generated using the NC generation to different RLC entities wherein total number of RLC entities is determined in step 516. For example, the WTRU (e.g., UE) may submit systematic NC PDUs generated using the NC generation to one set of RLC entities and non-systematic NC PDUs, generated using the NC generation, to second set of RLC entities. The method may go to step 519.

In step 518: the WTRU (e.g., UE) may submit NC PDU to available RLC entity.

In step 519: end of WTRU (e.g., UE) processing to determine transmission path of an NC PDU generated using an NC generation.

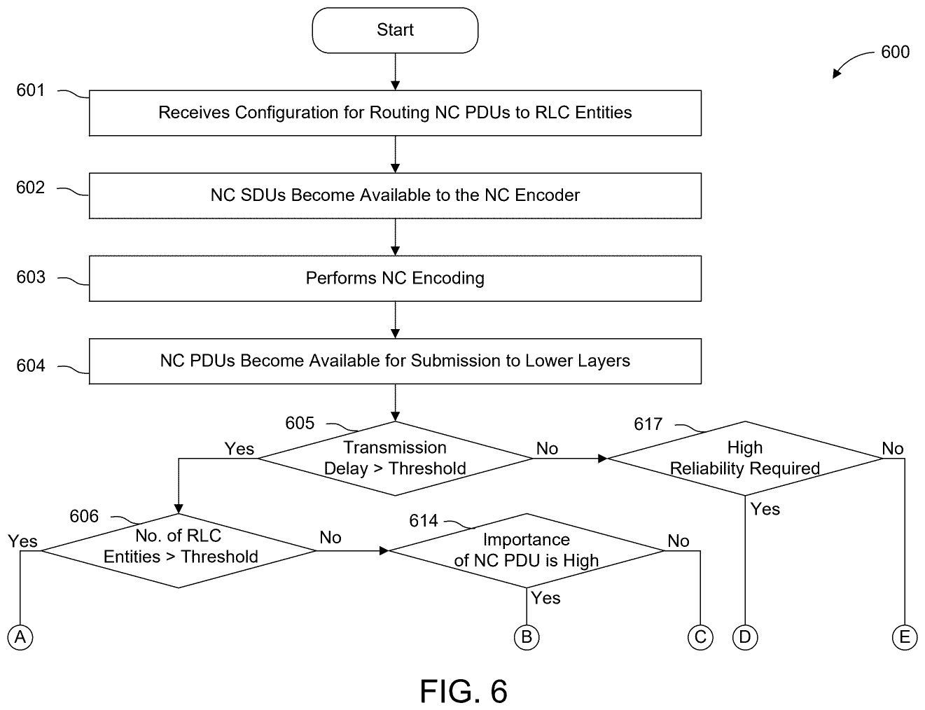

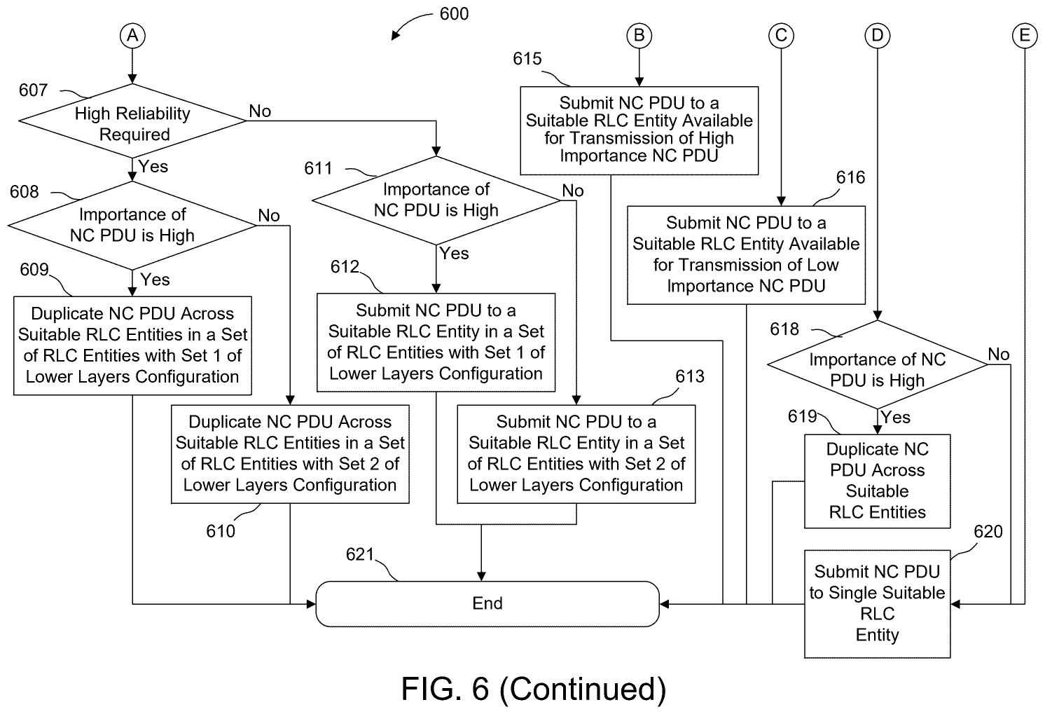

Following is an example of a method 600 of WTRU (e.g., UE) processing, as shown in FIG. 6, to determine how to route an NC PDU to RLC entities when the WTRU (e.g., UE) is configured with more than one routing mechanism for routing NC PDUs. It is assumed in this example that the WTRU (e.g., UE) routes NC PDUs to one or more RLC entities based on importance of NC PDU. It is also assumed that a first set or set 1 of lower layers configuration provides higher transmission reliability than a second set or set 2 of lower layers configuration.

In step 601: the WTRU (e.g., UE) may receive configuration to determine mechanism (rule-based split v/s selective mapping v/s rule-based duplication) to route NC PDU to one or more RLC entities. For this illustration, it is assumed that the received configurations include the following:

The received configuration may comprise information indicating a threshold on transmission delay on the air interface (denoted herein as delayₜₕᵣ) to determine whether to use split mehcanims or rule based duplication of NC PDUs generated using an NC generation.

The received configuration may comprise information indicating a threshold on number of RLC entities (denoted herein as N_{RLC,thr}) to determine whether to use rule based split mehcanims or selective mapping for routing of NC PDUs generated using an NC generation.

The received configuration may comprise information indicating criteria to determine if NC PDUs require transmission with high reliability based on radio conditions and NC code rate of the NC generation used to generate NC PDUs.

The received configuration may comprise information indicating a criteria to determine if importance of NC PDU is high or low as a function of one or more of the remaining delay budget of NC PDU, level of innovativeness, type of NC PDU, importance of NC SDU(s) associated with the NC generation used to generate the NC PDU and number of NC PDUs required to recover NC SDUs forming the NC generation used to generate the NC PDU, as proposed above.

In step 602, 603 & 604: Upon arrival of NC SDUs in the buffer, the WTRU (e.g., UE) may perform NC encoding and NC PDUs become available for submission to lower layers i.e., RLC entities.

In step 605: If transmission delay on the air interface is greater than the threshold delayₜₕᵣ, go to step 606. Otherwise, the method may go to step 617.

In step 606: If number of available RLC entities is greater than the threshold N_{RLC,thr}, the method may go to step 607. Otherwise, the method may go to step 614.

In step 607: the WTRU (e.g., UE) may evaluate criteria in 1-c to determine if high reliability is needed for transmission of NC PDUs. For instance, the WTRU (e.g., UE) may determine NC PDUs generated using NC generation require high transmission reliability, if link quality based on radio measurement is below a threshold and NC code rate is above a threshold. If high reliability is used (e.g., needed), go to step 608, otherwise the method may go to step 611.

In step 608: If importance of NC PDU is high, the method may go to step 609. Otherwise, the method may go to step 610.

In step 609: the WTRU (e.g., UE) may duplicate NC PDU across suitable RLC entities, available for transmission, from set of RLC entities with first set of lower layer configurations. The method may go to step 621.

In step 610: the WTRU (e.g., UE) may duplicate NC PDU across suitable RLC entities, available for transmission, from set of RLC entities with second set of lower layer configurations. The method may go to step 621.

In step 611: If importance of NC PDU is high, the method may go to step 612. Otherwise, the method may go to step 613.

In step 612: the WTRU (e.g., UE) may submit NC PDU to a suitable RLC entity, available for transmission, from set of RLC entities with first set of lower layer configurations. The method may go to step 621.

In step 613: the WTRU (e.g., UE) may submit NC PDU to a suitable RLC entity, available for transmission, from set of RLC entities with second set of lower layer configurations. The method may go to step 621.

In step 614: If importance of NC PDU is high, go to step 615. Otherwise, the method may go to step 616.

In step 615: the WTRU (e.g., UE) may submit NC PDU to a suitable RLC entity available for transmission of NC PDU with high importance. The method may go to step 621.

In step 616: the WTRU (e.g., UE) may submit NC PDU to a suitable RLC entity available for transmission of NC PDU with low importance. The method may go to step 621.

In step 617: the WTRU (e.g., UE) may evaluate criteria in 1-c to determine if high reliability is used (e.g., needed) for transmission of NC PDUs. For instance, the WTRU (e.g., UE) may determine NC PDUs generated using NC generation require high transmission reliability, if link quality based on radio measurement is below a threshold and NC code rate is above a threshold. If high reliability is used (e.g., needed), the method may go to step 618, otherwise go to step 620.

In step 618: If importance of NC PDU is high, the method may go to step 619. Otherwise, the method may go to step 620.

In step 619: the WTRU (e.g., UE) may duplicate NC PDU across multiple suitable RLC entities available for transmission of NC PDU. The method may go to step 621.

In step 620: the WTRU (e.g., UE) may submit NC PDU to a single suitable RLC entity available for transmission of NC PDU.

In step 621: end of WTRU (e.g., UE) processing to determine transmission path of an NC PDU generated using an NC generation.

Following is an example of a realization of WTRU (e.g., UE) processing to determine how to route NC PDUs generated using an NC generation to RLC entities when the WTRU (e.g., UE) is configured with more than one routing mechanism for routing NC PDUs.

In a first step, the WTRU (e.g., UE) may receive a configuration.

The received configuration may comprise information indicating a set of RLC entities with one or more path characteristics e.g., allowed NC PDU characteristics, MCS values, grant type, carrier type, cell group type, mode of data transfer etc.

The received configuration may comprise information indicating different mechanisms (e.g., rule-based split, selective mapping, rule-based duplication etc.) the WTRU (e.g., UE) may use to route NC PDUs generated using an NC generation to one or more RLC entities.

The received configuration may comprise information indicating an index associated with each of the configured NC PDU routing mechanism.

The received configuration may comprise information indicating conditions associated with each configured routing mechanism to determine how to route NC PDUs generated using an NC generation to different RLC entities as per the associated routing mechanism. For example, for rule-based duplication the configuration may indicate which characteristic (e.g., type, innovativeness, remaining delay budget, importance etc.) to consider when performing duplication and the associated rule to use (e.g., NC PDU type is considered for rule based duplication which type of NC PDU is to be duplicated and which type is to be routed to single path).

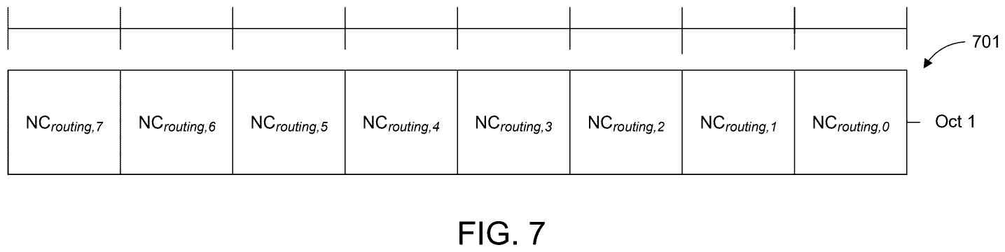

In a second step, the WTRU (e.g., UE) may receive a control PDU, e.g., an NC PDU routing Activation/Deactivation MAC CE 701 (see FIG. 7), which activates one or more of the configured mechanisms for routing the NC PDUs. The MAC CE may be identified by a MAC sub-header with a new LCID specific to NC PDU routing Activation/Deactivation MAC CE. The LCID may be one octet long. The size of the control field may be fixed e.g., single octet as shown in FIG. 7, wherein each bit may have one-to-one mapping with the configured NC PDU routing mechanism.

In a third step, the WTRU (e.g., UE) may determine an activation/deactivation status of i-th configured NC PDU routing mechanism from the control field of Activation/Deactivation MAC CE received in the second step. The field NC_{routing,i} may indicate the activation/deactivation status of the NC PDU routing mechanism i where i is in the ascending order of the NC PDU routing mechanism index/ID among the mechanisms the WTRU (e.g., UE) is configured with. If the NC_{routing,i} field is set to 1, the WTRU (e.g., UE) may determine that the NC PDU routing mechanism i shall be activated. If the NC_{routing,i} is set to 0, the WTRU (e.g., UE) may determine that the NC PDU routing mechanism i shall be deactivated.

In a fourth step, the WTRU (e.g., UE) may use the activated mechanism for routing of NC PDUs generated using an NC generation to the suitable paths, e.g., RLC entities, based on the rules in the received configuration.

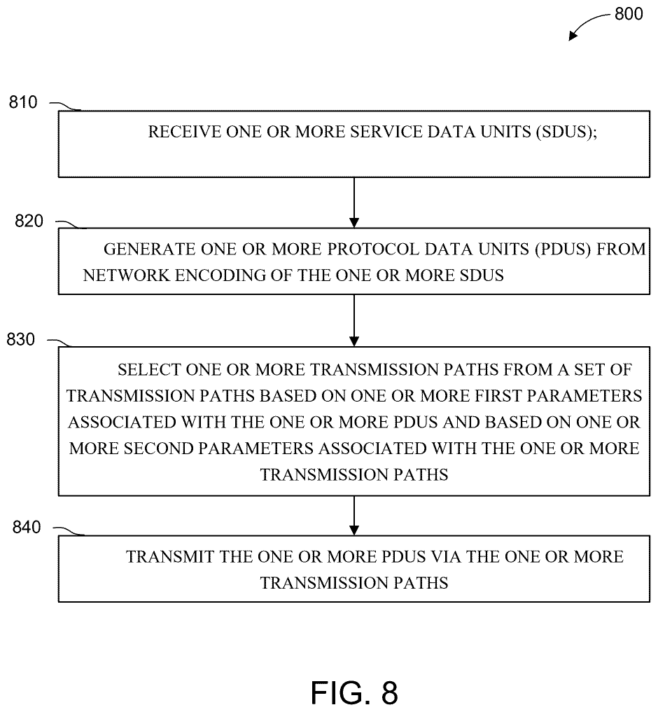

FIG. 8 illustrates an example of a routing method 800 implemented by a WTRU 102.

The WTRU 102 may receive one or more service data units (SDUs) (step 810).

The WTRU 102 may generate one or more protocol data units (PDUs) from network encoding of the one or more SDUs (step 820).

The WTRU 102 may select one or more transmission paths from a set of transmission paths, for example, based on one or more first parameters associated with the one or more PDUs and/or based on one or more second parameters associated with the one or more transmission paths (step 830).

The WTRU 102 may transmit the one or more PDUs via the one or more transmission paths (step 840).

According to certain embodiments, the WTRU 102 may be configured to: receive configuration information indicating one or more criteria for mapping the one or more PDUs to the one or more transmission paths.

According to certain embodiments, the one or more transmission paths may be selected based on the configuration information.

According to certain embodiments, the one or more criteria may comprise any of: (1) a remaining delay budget value associated with the one or more PDUs; (2) one or more coding coefficients associated with the generation of the one or more PDUs; or (3) a number of PDUs required to recover the one or more SDUs.

According to certain embodiments, the one or more second parameters may comprise any of: (1) a link quality, (2) one or more allowed modulation and coding scheme values, (3) one or more allowed grant type, (4) one or more allowed network coded PDU characteristics, (5) one or more carrier type, (6) one or more cell group type, or (7) one or more mode of data transfer.

According to certain embodiments, the one or more PDUs may be generated using a network coding code rate.

According to certain embodiments, the one or more transmission paths may be selected based on a comparison of the network coding code rate and a first threshold value.

According to certain embodiments, the one or more first parameters may comprise any of: (1) a remaining delay budget value associated with the one or more PDUs, (2) one or more coding coefficients associated with the generation the one or more PDUs, (3) a number of PDUs required to recover the one or more SDUs, (4) a type of PDU associated with the one or more PDUs, or (5) one or more quality of service levels associated with the one or more PDUs.

According to certain embodiments, the WTRU 102 may be configured to: determine, based on the one or more first parameters, a priority value associated with the one or more PDUs.

According to certain embodiments, the one or more transmission paths may be selected based on a comparison of the priority value and a second threshold value.

According to certain embodiments, the one or more transmission paths may be selected based on a comparison of a remaining delay budget value associated with the one or more PDUs and a third threshold value.

According to certain embodiments, the one or more transmission paths may be selected based on a type of PDU associated with the one or more PDUs.

According to certain embodiments, the type of PDU may correspond to a systematic PDU, or a non-systematic PDU.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. §112, ¶6 or means-plus-function claim format, and any claim without the terms “means for” is not so intended.

What is claimed is:

1. A method implemented by a wireless transmit/receive unit (WTRU), the method comprising:
receiving one or more service data units (SDUs);
generating one or more protocol data units (PDUs) from network encoding of the one or more SDUs;
selecting one or more transmission paths from a set of transmission paths based on one or more first parameters associated with the one or more PDUs and based on one or more second parameters associated with the one or more transmission paths; and
transmitting the one or more PDUs via the one or more transmission paths.

2. The method of claim 1, further comprising:
receiving configuration information indicating one or more criteria for mapping the one or more PDUs to the one or more transmission paths, wherein selecting the one or more transmission paths is based on the configuration information.

3. The method of claim 2, wherein the one or more criteria comprise any of: (1) a remaining delay budget value associated with the one or more PDUs; (2) one or more coding coefficients associated with the generation of the one or more PDUs; or (3) a number of PDUs required to recover the one or more SDUs.

4. The method of claim 1, wherein the one or more second parameters comprise any of: (1) a link quality, (2) one or more allowed modulation and coding scheme values, (3) one or more allowed grant type, (4) one or more allowed network coded PDU characteristics, (5) one or more carrier type, (6) one or more cell group type, or (7) one or more mode of data transfer.

5. The method of claim 1, wherein the one or more PDUs are generated using a network coding code rate; and wherein selecting the one or more transmission paths is based on a comparison of the network coding code rate and a first threshold value.

6. The method of claim 1, wherein the one or more first parameters comprise any of: (1) a remaining delay budget value associated with the one or more PDUs, (2) one or more coding coefficients associated with the generation the one or more PDUs, (3) a number of PDUs required to recover the one or more SDUs, (4) a type of PDU associated with the one or more PDUs, or (5) one or more quality of service levels associated with the one or more PDUs; and further comprising:
determining, based on the one or more first parameters, a priority value associated with the one or more PDUs; and wherein selecting the one or more transmission paths is based on a comparison of the priority value and a second threshold value.

7. The method of claim 1, wherein selecting the one or more transmission paths is based on a comparison of a remaining delay budget value associated with the one or more PDUs and a third threshold value.

8. The method of claim 1, wherein selecting the one or more transmission paths is based on a type of PDU associated with the one or more PDUs.

9. The method of claim 8, wherein the type of PDU corresponds to a systematic PDU, or a non-systematic PDU.

10. A wireless transmit/receive unit (WTRU) comprising circuitry, including a transmitter, a receiver, a processor and memory, the WTRU configured to:
receive one or more service data units (SDUs);
generate one or more protocol data units (PDUs) from network encoding of the one or more SDUs;
select one or more transmission paths from a set of transmission paths based on one or more first parameters associated with the one or more PDUs and based on one or more second parameters associated with the one or more transmission paths; and
transmit the one or more PDUs via the one or more transmission paths.

11. The WTRU of claim 10, further configured to:
receive configuration information indicating one or more criteria for mapping the one or more PDUs to the one or more transmission paths, wherein the one or more transmission paths are selected based on the configuration information.

12. The WTRU of claim 11, wherein the one or more criteria comprise any of: (1) a remaining delay budget value associated with the one or more PDUs; (2) one or more coding coefficients associated with the generation of the one or more PDUs; or (3) a number of PDUs required to recover the one or more SDUs.

13. The WTRU of claim 10, wherein the one or more second parameters comprise any of: (1) a link quality, (2) one or more allowed modulation and coding scheme values, (3) one or more allowed grant type, (4) one or more allowed network coded PDU characteristics, (5) one or more carrier type, (6) one or more cell group type, or (7) one or more mode of data transfer.

14. The WTRU of claim 10, wherein the one or more PDUs are generated using a network coding code rate; and wherein the one or more transmission paths are selected based on a comparison of the network coding code rate and a first threshold value.

15. The WTRU of claim 10, wherein the one or more first parameters comprise any of: (1) a remaining delay budget value associated with the one or more PDUs, (2) one or more coding coefficients associated with the generation the one or more PDUs, (3) a number of PDUs required to recover the one or more SDUs, (4) a type of PDU associated with the one or more PDUs, or (5) one or more quality of service levels associated with the one or more PDUs; and wherein the WTRU is further configured to: determine, based on the one or more first parameters, a priority value associated with the one or more PDUs; and wherein the one or more transmission paths are selected based on a comparison of the priority value and a second threshold value.

16. The WTRU of claim 10, wherein the one or more transmission paths are selected based on a comparison of a remaining delay budget value associated with the one or more PDUs and a third threshold value.

17. The WTRU of claim 10, wherein the one or more transmission paths are selected based on a type of PDU associated with the one or more PDUs.

18. The WTRU of claim 17, wherein the type of PDU corresponds to a systematic PDU, or a non-systematic PDU.
